(19) United States
(12) Patent Application Publication
(10) Pub. No.: US 2009/0327893 A1
(43) Pub. Date: Dec. 31, 2009

(54) COORDINATED VIDEO PRESENTATION METHODS AND APPARATUS

(76) Inventors: Paul Terry, Vancouver (CA); Ronald Leonard Westfall, North Vancouver (CA)

Correspondence Address: OYEN, WIGGS, GREEN & MUTALA LLP;480 - THE STATION, 601 WEST CORDOVA STREET, VANCOUVER, BC, V6B 1G1, CA

(21) Appl. No.: 12/146,323

(22) Filed: Jun. 25, 2008

(51) Int. Cl. G06F 3/14

(52) U.S. Cl. 715/719

(57) ABSTRACT

A coordinated video presentation comprises a plurality of sets of video content that is displayed in display areas on a display. The display areas each correspond to a video session playing one of the sets of video content. The display areas move on trajectories. Video objects can move among the video sessions. The display may display controls or other interactive graphical user interface elements. A user can interact with the interactive elements that are not obstructed by the coordinated video session.

### TECHNICAL FIELD

This invention relates to video. The invention has particular application to delivering video by way of multi-use displays, such as computer displays.

### BACKGROUND

Motion picture technology is evolving. Film has been the media traditionally used for movies. Television is used for daily entertainment. More recently, desktop computers and their graphic displays have been used to display motion pictures (e.g. movies, live TV, game animation, web-delivered YouTube™ videos). The use of computers in the creation, production and display of moving pictures is making possible new ways for viewers to enjoy moving pictures.

A wide range of computer software applications exist for playing video content on a computer screen. For example, QuickTime™ available from Apple Corporation, Windows Media Player available from Microsoft Corporation, RealPlayer™ available from RealNetworks, Inc. and other applications allow video content to be played back within a window on a computer screen.

Traditionally a movie screen or a television was used to display one program (i.e. a single video presentation) at a time. Picture-in-picture technology permits a television viewer to watch one program while previewing another program. Computer graphical user interface (“GUI”) technologies have extended this paradigm by allowing a user to work with multiple applications concurrently. Web technologies have taken this even further. Some internet web sites present video and animated advertising that appears to move over underlying web site content in an attempt to capture the viewer's attention. A noteworthy aspect of this evolution is that a video application can no longer assume that it has complete control and dedicated use of the display. The presentation may have to share the display with other presentations or other multimedia content (e.g. a desktop computer application window).

The MPEG-4 standard (ISO/IEC 14496 MPEG-4 standard) includes a number of capabilities. One such capability is arbitrarily shaped video. This is accomplished by providing a bit mask for each frame of a rectangular format video. The bit mask is rectangular and the same size as the video frame. A bit in the bit mask specifies whether or not the corresponding pixel in the video frame is to be displayed (i.e. whether or not the pixel should be transparent). By turning off all of the pixels except for the desired pixels, arbitrary shape video is possible. A variation of this capability can specify pixel transparencies between 0 and 100%. This capability is described as “shape-coded video”. Consider now a video player application window being used to display a video segment. When a video segment recorded in the MPEG-4 format is played on a video player application, the video player application may display either rectangular or non-rectangular video, as specified by the MPEG-4 video data within a rectangular region of the display.

Despite the strides that have been made in the creation, delivery and display of video content, there remains a need and an opportunity for ways to present video that are interesting to viewers.

### SUMMARY

This invention relates to coordinated video presentations. The invention has a number of different aspects.

One aspect of the invention provides methods for presenting coordinated video presentations. The methods of this aspect comprise displaying first video content in a first video session within a first area on a display. The first area occupies less than all of the display. While displaying the first video content in the first area, the method causes the first area to traverse a first trajectory on the display until the first area is in a predetermined spatial relationship to a second area on the display corresponding to a second video session. In the predetermined spatial relationship, the first area is abutting or overlapping the second area. While the first area is abutting or overlapping the second area the method depicts a first video object from the first video content in the first area and transitions the first video object to the second video session and subsequently depicts the first video object from the second video content in the second area.

Another aspect of the invention provides a method for displaying a coordinated video presentation. The method comprises displaying on a display one or more interactive elements of a graphical user interface. The method also comprises, on the display: displaying a plurality of windows; playing related video content in each of the plurality of windows; and, for one or more of the plurality of windows, moving the one or more windows on the display, based at least in part on predetermined trajectory information, while playing the video content in the one or more windows.

Another aspect of the invention provides apparatus for playback of coordinated video presentations.

Another aspect of the invention provides apparatus for performing a coordinated video presentation. The apparatus comprises a display and a plurality of buffers. Each of the buffers is respectively associated by an operating system with a corresponding one of a plurality of areas of the display. Software running under the operating system is configured to: write video content into each of the plurality of buffers; and, move a location of one or more of the areas of the display in synchronization with the video content according to trajectory data.

Another aspect of the invention provides a program product that carries computer instructions in a computer-accessible format. The computer instructions, when executed by a data processor connected to control a display cause the data processor to display a coordinated video presentation on the display.

In some embodiments, multiple frame buffers are passed to an operating system together with instructions regarding time-varying locations of corresponding display areas where video objects from the frame buffers ought to be displayed on a display. In some embodiments, sizes and/or shapes of the display areas may be varied dynamically. In some embodiments, sizes of the corresponding frame buffers are varied dynamically during playback of coordinated video presentations.

Embodiments of the invention as described herein facilitate delivery of coordinated video presentations. Such presentations may be delivered on displays that include interactive elements not part of the coordinated video presentation. In such embodiments, the display areas for the coordinated video presentation need only occupy that portion of the display required by the display areas as they are moved about the display. The windows need be no bigger than the depicted video objects. In some embodiments, this significantly reduces the total size of data that must be composited for each frame. It is unnecessary to allocate a frame buffer that is large enough to accommodate all displayed video objects and the spaces between them. Furthermore, in some embodiments, a coordinated video display can be scaled without scaling individual video objects that are part of the video display. This permits scaling to present the coordinated video presentation on displays of different sizes or within display areas of different sizes without affecting the compositing of individual video sessions that are presented as parts of the coordinated video presentation. In such embodiments, the trajectories of video sessions can be scaled without scaling the video sessions themselves.

In addition to the exemplary aspects and embodiments described above, further aspects and embodiments will become apparent by reference to the drawings and review of the following detailed description.

### BRIEF DESCRIPTION OF DRAWINGS

Example embodiments are illustrated in the accompanying non-limiting drawings.

FIG. 1 illustrates schematically a prior art system for presenting video on a computer display.

FIG. 2 is a block diagram illustrating apparatus according to an example embodiment.

FIG. 3 illustrates transitioning a video object from one video session to another.

FIG. 3A illustrates a possible transitioning mode.

FIGS. 4A and 4B illustrate a transitioning mode in which video session windows overlap one another.

FIG. 4C is a flow chart of a method illustrating the transition of a video object from a first video session to a second video session.

FIG. 5 illustrates a transitioning mode that applies a bridging window.

FIG. 6 illustrates one way to make a video object being displayed in a window that is in the foreground appear to be in the background relative to a video object being displayed in a window that is in the background.

FIGS. 7, 8 and 9 are views of a display that illustrate example applications.

FIG. 10 illustrates transitioning video objects across multiple parts of a boundary of a window that overlaps another window.

FIG. 11 illustrates a window moving along a trajectory between events in which video content of the window interacts with video content of other windows.

FIGS. 12A and 12B respectively depict two different displays of different sizes and aspect ratios and illustrate how trajectories of windows may be altered to accommodate different display areas. FIG. 12C shows a trajectory extending between a starting point and an ending point.

FIG. 13 illustrates altering the terminal position of a trajectory of a window by varying a size of the window as the window is moved along its trajectory.

FIG. 14 illustrates altering the terminal position of a trajectory of a window by adding or removing frames from a video sequence displayed while the window is moved along its trajectory.

FIG. 15A illustrates a coordinated video presentation in which trajectories and playback of video can be adjusted to maintain coordination of the timing of events in different video sessions.

FIG. 15B illustrates altering the time at which a video sequence is completed to maintain synchronization with an upcoming event.

FIG. 16 illustrates apparatus according to an example embodiment having a centralized manager functioning in a computer apparatus to provide a coordinated video presentation.

FIG. 17 illustrates an embodiment wherein control data for choreographing the playback of video in a plurality of windows is contained in corresponding video data.

FIG. 18 is a graph representing the choreography of a coordinated video presentation.

FIG. 19 is a block diagram of a system for delivering coordinated video presentations over data communication networks.

### DESCRIPTION

Throughout the following description specific details are set forth in order to provide a more thorough understanding to persons skilled in the art. However, well known elements may not have been shown or described in detail to avoid unnecessarily obscuring the disclosure. Accordingly, the description and drawings are to be regarded in an illustrative, rather than a restrictive, sense.

### Definitions

Terms that are used in this application and defined in this section have the meanings set out in this section unless otherwise stated or necessarily implied.

“Display” means any venue where video technology can be displayed. Display includes movie screens, television screens, computer display devices, digital projection displays, electronic billboards, stadium video displays, displays of portable devices such as video-enabled cellular telephones or personal digital assistants, etc. A display may exist within another display. For example, a video player window and a web browser window are each a display. Such windows can exist on a computer display.

“Fission” or “Video Fission” means an interaction wherein a first video session is initially displaying video data representing a plurality of video objects including at least first and second video objects and, during the interaction, one of the first and second video objects is transitioned to a second video session such that, after the interaction, the first and second video objects are represented by video data for different video sessions.

“Fusion” or “Video Fusion” means an interaction wherein a first video session is initially displaying video data representing a first video object, a second video session is initially displaying video data representing a second video object and, at least one of the first and second video objects is transitioned into another video session such that, after the interaction, the first and second video objects are both represented by video data in the same video session.

“Interactive Display” means a Display which displays at least some controls of a graphical user interface that can be actuated by a user. Examples of interactive display include computer monitors, touch screens, and the like.

“Trajectory” means a path followed by a thing such as an object, window, or the like over some period of time. Trajectory includes the case where a thing remains in the same place over the period of time. A trajectory may be specified, for example, by a function or functions. For example, a trajectory may be defined by specifying the position P of an object or window as P=(X(t), Y(t)); where X(t) and Y(t) are some functions of time. A trajectory may also include changes in a Z-order as a function of time. For example, a trajectory may be specified by P=(X(t), Y(t), Z(t)) where Z(t) is a Z-order specified as a function of time. A trajectory may also be specified by a plurality of discrete points. For example, a trajectory for a window displaying video may be specified by a location for the window corresponding to each video frame. As another example, a trajectory may be specified by a plurality of locations for the window at different times coupled with some rules for determining what path the window follows at other times. For example, a trajectory may specify that a window will move in a straight line between two points. As another example, a trajectory may be specified as a mathematical function that provides locations for a window as a function of time.

“Transparent” when applied to a pixel of a window or area means that an appearance of the pixel is determined at least in part by an underlying (e.g. lower in Z-order) window or area. Objects in underlying windows can be made visible by making overlying windows transparent or partially transparent.

“Video exchange” means the bidirectional transfer of one or more video objects between video sessions.

“Video Session” means a video player displaying video content within a corresponding display area on a display. In some embodiments, each video session composites image data into a buffer and the buffer contents determine the appearance of the corresponding display area on the display. Each video session may have a buffer or set of buffers that is distinct from buffers of any other concurrent video sessions.

“Video Source” means a source of video data. Video source includes: pre-recorded video from a video camera, a data file defining an animation sequence, computer software that generates video data (video game software is an example of a video source) and the like.

“Video Object” means a thing depicted in a video image. A video object may comprise a collection of other video objects. Non-limiting examples of video objects are persons, animals, furniture, balls, sporting equipment, and other objects depicted in video images. A video object may be photo-realistic or drawn to any desired level of detail. A video object may be sourced from video images acquired by a camera or cameras, drawn under application control, assembled from digitized images, or the like.

“Video Technology” or “Video” refers to any technology for producing an image which appears to a viewer to be two- or three-dimensional and which contains at least one video object which appears to move.

“Window”, “Display Region” and “Display Area” are terms that mean a region of a display controlled by a computer for which an application can supply an image content for display in the region of the display. A window may be provided by a window mechanism supported by a computer's operating system. A window may be any shape. Windows provided by existing computer operating systems are typically rectangular. For example, a rectangular region within a web browser window, a region of a movie screen, an area on a television screen or on an electronic billboard for which an application can specify image data are examples of windows. A window may have a border but does not necessarily have a border. If the window is specified by a graphical user interface, the operating system may allow display of the window's border to be suppressed. In some embodiments, when this is done, only the image content corresponding to the window is displayed.

### Prior Art

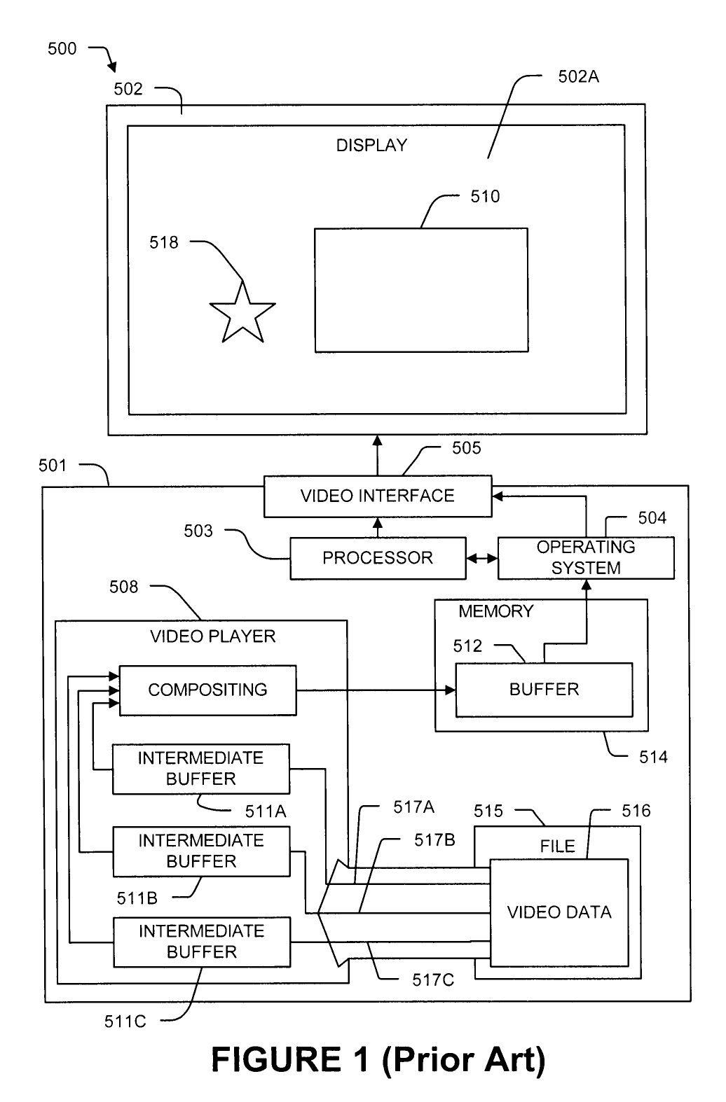

FIG. 1 illustrates a prior art system 500 that comprises a computer 501 having a display 502 and a processor 503 running an operating system 504. Operating system 504 may, for example comprise the Microsoft Windows™ operating system or the Apple OS X operating system, for example. A display interface 505 drives display 502.

Video player software 508 runs under operating system 504 which allocates a window 510 within an image area 502A of display 502 for display of images from video player software 508. Operating system 504 allocates a buffer 512 in a memory 514 of computer 501 that corresponds to window 510. Video player software 508 can cause images to be displayed within window 510 by writing image data into buffer 512. The size and position of window 510 within display area 502A are specified by operating system 504 in response to user input. For example, the user can position window 510 within display area 502A by dragging window 510 with a cursor controlled by a suitable pointing device and a user can resize window 510 using the cursor.

In the illustrated embodiment, video player software 508 is playing video images from a file 515 containing video data 516 in an MPEG-4 format. Video data 516 comprises multiple streams 517 of video data (streams 517A to 517C, collectively streams 517 are illustrated). Each stream 517 is processed by video player software 508 to yield image data that is placed in a corresponding intermediate buffer 511 (intermediate buffers 511A, 511B and 511C are shown) and the resulting images are composited together into buffer 512. This causes video to be displayed in window 510. The video can be seen by a user as long as it is not obstructed by another window that overlaps with and is in front of window 510.

If window 510 is large then very significant computing resources may be required to composite all of the data into buffer 512 and to cause corresponding video data to be displayed in window 510. Window 510 must be large enough to accommodate all video to be displayed, including any transparent portions of the video. Buffer 512 must be large enough to contain image data for the entire region of window 510.

If window 510 overlaps with an object, such as an icon 518 displayed on display 502 then icon 518 may be obscured. Video data 516 may specify that certain regions within window 510 are ‘transparent’ in which case an underlying icon or other object 518 may be visible to a user. However, even if an underlying icon 518 is visible to the user, the user usually cannot interact with icon 518 (e.g. by clicking on it). In a typical computing environment having a GUI, a cursor is controlled by a pointing mechanism or a touch screen is provided. A control input such as a button click, a touch at a particular screen location or the like is typically interpreted as a command to be processed by the window or other display feature that is most in the foreground. Where the foreground window is a window of a video player, making pixels transparent so that an underlying control or the like can be confusing to a user who sees a control (e.g. icon 518) through the transparent portion of the overlying window but cannot interact with the control in a normal way. This can be particularly confusing to a user if display of a border of the video player window is suppressed.

### Example Embodiments of the Invention

This invention provides apparatus and methods for concurrently displaying two or more coordinated video sessions in such a manner that all or part of one or more video objects appears to move between the video sessions. By way of example, in some embodiments:
One or more video objects initially displayed in one video session are split among two or more separate concurrently displayed video sessions (“fission”).
One or more video objects from one or more video sessions move into another video session that is displaying at least one other object (“fusion”).
One or more video objects from one video session can move into an adjacent or overlapping video session.

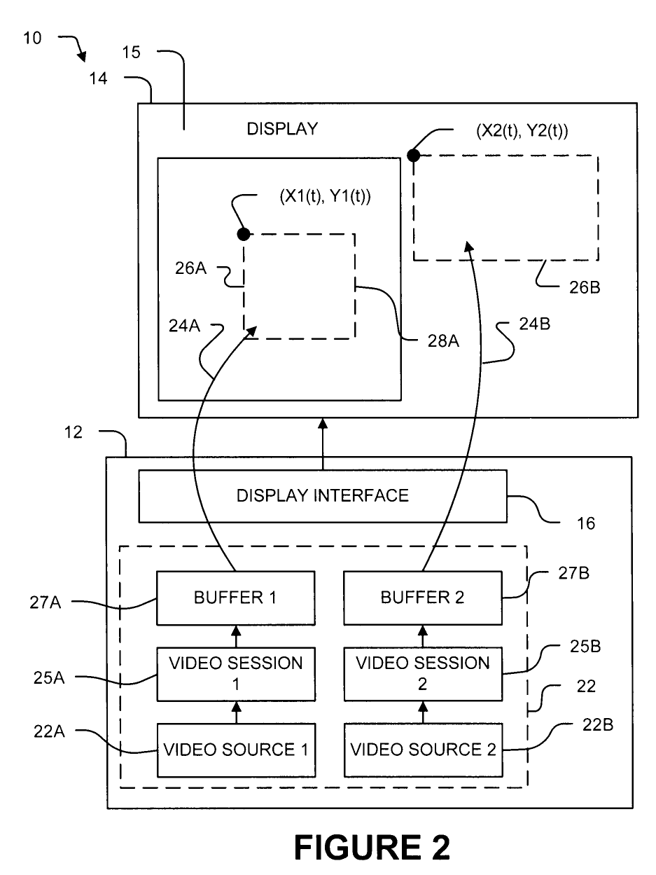

FIG. 2 shows apparatus 10 according to an example embodiment. Apparatus 10 comprises a controller 12 which supplies control signals to display images on a display 14. Controller 12 comprises a display interface 16. Display interface 16 generates signals which cause images to appear on display 14.

Controller 12 includes a coordinated video source 22. Coordinated video source 22 comprises a first video source 22A and a second video source 22B. First video source 22A provides first video content 24A for a first video session 25A. Second video source 22B provides second video content 24B for a second video session 25B. Video sessions 25A and 25B are referred to collectively as video sessions 25. Video images from first and second video sessions 25A and 25B can be displayed in corresponding display areas 26A and 26B (collectively display areas 26) at corresponding locations on display 14. Display areas 26A and 26B respectively have locations (X1, Y1) and (X2, Y2) on a display area 15 of display 14. The locations of display areas 26 may change with time. Other objects such as application windows or other image content not provided by coordinated video source 22 may also be displayed on display area 15.

Advantageously, apparatus 10 provides a separate buffer for compositing video content to be displayed in each display area 26A and 26B (and generally, a separate buffer for each display area 26). Each buffer need only be large enough to hold video content for the corresponding display area. Display areas 26 may be wrapped tightly around the video objects to be displayed in them. Thus, in some cases the buffers may be much smaller (for example, a factor of 5 or more or 10 or more or 100 or more in some cases), in aggregate, than a buffer capable of buffering data for the full area of display 14 or a single display area encompassing all of display areas 26. Further, since the buffers can be individually relatively small, the overhead of handling each buffer is decreased and higher frame rates can be maintained for video content in individual display areas 26 even with computational resources that would be insufficient to maintain the same frame rate for a full screen video presentation on display 14.

The illustrated embodiment includes separate buffers 27A and 27B (collectively buffers 27) that are allocated for handling video content for corresponding display areas 26. In some embodiments, display areas 26 are resized dynamically (resizing may include one or both of changing an area and an aspect ratio or other shape characteristic of a display area 26). Buffers 27 may also be dynamically resized in a corresponding manner. When the video objects for a display area 26 are small and close together only a small display area 26 is required and the corresponding buffer 27 may also be small. Larger display areas 26 and larger corresponding buffers 27 are required in cases where the coordinated video presentation requires a single display area 26 to depict a large video object or a number of spatially separated video objects.

In addition to providing video content for video sessions 25, coordinated video source 22 provides trajectory information for display areas 26 corresponding to video sessions 25. The trajectory information may be embedded in the signals that carry video content or may be provided in the form of separate signals to which display interface 16 responds by moving display areas 26 in the specified manner. The trajectory information may specify positions for display areas 26 at certain times, changes in those positions with time and may also specify additional information such as: dimensions for the display area (which may change with time); whether or not to display a display area corresponding to a video session at a particular time; and/or a Z-order for the display area corresponding to each video session.

A Z-order coordinate is typically used to resolve the display of overlapping entities. In such cases, the entity that is ‘closer’ to the viewer, as determined by its Z-order (i.e. in the foreground as compared to another entity) is displayed and clips the ‘underlying’ entity. In some embodiments, the Z-order may be changed in time. It is not necessary for two video sessions or windows to have the same Z-order to be considered adjacent to one another. Adjacency is a characteristic of position in the plane of a display as determined, for example, by X and Y coordinates.

The positions for display of video data for video sessions 25 may be specified in any suitable coordinate system. The coordinate system may be an absolute coordinate system which specifies location relative to a fixed point on display area 15 or a relative coordinate system which specifies positions of one or more video sessions 25 relative to another video session 25, relative to display area 15 or relative to something else. The coordinates may be specified in terms of any of:
pixels (e.g. Y=302 pixels down from top edge of display and X=577 pixels to the right of the left edge of the display);
inches, centimeters or some other absolute unit or units of length;
percentages of some characteristic size, such as a size of display area 15 (e.g. X=5% of the width of the display area measured from the left edge of the display and Y=43% of the height of the display measured from the top of the display area, or X=88% of the diagonal size of the display area and Y=4% of the diagonal size of the display area, each measured from some appropriate starting point);
scale units (e.g. X and Y could each be specified in a range of 0 to 100 with the meaning of the scale units determined by a scale factor or scale factors that relate the scale units to numbers of pixels or absolute distances);
a desired relationship between different display windows or other display regions (e.g. the specification may indicate that: a set of windows are evenly spaced across all or an available portion of display area 15; a set of windows are spaced apart so that spaces between them have assigned sizes relative to one another in X, Y and or Z directions; etc.);
etc.
   Coordinates may be automatically generated in some embodiments. For example, in some embodiments, the location for display of a video image for one video session may be specified as having a defined relationship to one or more reference features which may comprise locations, video sessions, windows or other objects. The defined relationships may be relationships such as being: aligned with in a specified dimension, between, spaced apart from, etc. the reference feature(s).

The examples set out herein, unless otherwise noted, use an X, Y coordinate system to specify the location of a video session 25 or other entity. The X coordinate specifies a horizontal position between the left and right edges of the display. The Y coordinate specifies a vertical position between the top and bottom edges of the display. A Z coordinate specifies a Z-order for the entity.

Apparatus 10 may be applied to cause interesting visual effects. For example, video display areas 26 may be controlled to move along trajectories on display area 15 such that they are sometimes apart and are sometimes adjacent or overlapping with one another. Video objects may be transitioned among video sessions 25. The timing with which a video object is transitioned between two video sessions 25 may be coordinated with the trajectories of video display areas 26 such that the video object appears to move seamlessly between the video sessions 25. To a viewer, it may not be apparent that multiple video sessions are involved in displaying the observed video objects.

Embodiments of this invention can produce interesting visual effects by coordinating the presentation of video in two or more video sessions. Features that may be coordinated among the video sessions may include:
the video content of each video session (including the display and motion of video objects depicted by that video content);
positions on a display of windows or other display locations corresponding to the video sessions (and the way that those positions may change with time);
sizes of windows corresponding to the video sessions (and the ways that those sizes may change with time);
the overall shape of content being displayed within a window and/or the transparency status of points or regions within the window;
the commencement of and termination of display of windows corresponding to the video sessions;
shapes of windows corresponding to the video sessions (and the ways that those shapes may change with time);
rotation of video being displayed in a video session (and the way that the rotation may change with time)—the rotation may comprise rotation about one or more axes;
Z-order of windows corresponding to the video sessions (and the ways that those Z-orders may change with time).

Apparatus 10 maintains synchronization of the playback of content in video sessions 25 and the trajectories of video display areas 26. This may involve synchronization of timelines of video content 24 for different video sessions 25. In such a case, all pieces of video content 24 may have identical timelines or coordinated video source 22 may apply offsets to some or all of the timelines. Synchronization should be preserved over sudden jumps resulting from use of mechanisms such as fast forward, skip forward, and random access, if present.

Where a window for a video session is being moved along a trajectory then the trajectory may be designed such that motions of video objects depicted within the window appear to interact naturally with the display on which the window is being shown or with other things being shown on the display. For example, where the video object is a person and the video session of a window shows the person walking then the trajectory for the window may be specified such that the person appears to be walking without slipping on a ‘desktop’, the top of an unrelated window, or other background in the display. As another example, a video object may comprise a rolling ball. The trajectory of a window for a video session in which the rolling ball is depicted may be selected such that the ball appears to be rolling naturally over a desktop or other features in the background in the display.

As a simple example. Consider the case where first video source 22A of FIG. 2 provides video content showing a professional tennis player for display by first video session 25A in display region 26A. A video object having the appearance of a tennis ball could initially be present in first video session 25A. The tennis player could be shown hitting the tennis ball. At or before the time that the tennis ball video object reaches the boundary 28A of first video display area 26A the tennis ball object could be discontinued in first video session 25A and shown instead in second video session 25B. The tennis ball video object could continue to be shown in second video session 25B as the trajectory of display area 26B corresponding to second video session 25B takes it to the boundary of display area 15. Second video data 24B showing the tennis ball video object is created in such a manner that the motions resulting from the trajectory of second video display area 26B taken with any motion of the tennis ball video object within second video display area 26B results in the viewer observing a tennis ball moving in a desired manner across display area 15. The trajectory of video display area 26B may be controlled so that it moves back and forth between a position or positions wherein it is adjacent to or overlaps with first video display area 26A and a position or positions wherein it is adjacent to or overlaps a boundary of display area 15.

The tennis ball could be shown to bounce as if off of the boundary of display area 15 and to then travel back toward the image of the tennis player displayed by video session 25A. At some time when second video display area 26B is adjacent to or overlapping with first video display area 26A the tennis ball object could be discontinued in second video session 25B and shown instead in first video session 25A (which may depict the tennis player again hitting the tennis ball). Thus, this example could depict a tennis player bouncing a tennis ball around display area 15 of display 14.

Although video display areas 26 are depicted as being rectangular, this is not mandatory. Video display areas 26 may have other shapes if supported by display interface 16. For example, video display areas 26 may have shapes defined by a shape coding feature such as that provided in the MPEG-4 specification. In some such cases, pixels within a window assigned to the video session but outside of the designated shape may be designated to be completely or partially transparent. This is one way in which video sessions 25 may be configured to present arbitrary-shaped video.

In some embodiments, windows corresponding to one or more video sessions 25 are shaped and/or sized to conform closely to one or more depicted video objects. For example, the second video session depicting a tennis ball in this example may have a round shape to conform to the shape of the depicted tennis ball video object and/or may be sized so that it is only as large as necessary to accommodate the tennis ball or the tennis ball plus a margin around the tennis ball. This is achieved in some embodiments by providing a rectangular presentation region in which some pixels are set to be transparent, thus leaving a suitably-shaped region of non-transparent pixels that are controlled to deliver video images for the corresponding video session 25.

In this example embodiment, the display of coordinated video can be achieved while the windows or other regions in which video images corresponding to video sessions 25 are displayed correspond to only a small part of the area of display area 15. In some embodiments, the total size of buffers holding video data can be relatively small since only video images for the relatively small display windows or regions needs to be buffered. Further, the overall amount of video data needed for the coordinated video presentation may be much less than the amount of video data that would be required to produce a video presentation occupying the same overall area in a prior art system like that shown in FIG. 1.

Further, providing video objects (such as the tennis ball video object and the tennis player video object) together in a first video session at a first time (e.g. at the time that the tennis ball is depicted as being hit) facilitates depicting natural-looking interactions between the video objects (e.g. the tennis ball and the tennis player's racquet). Transitioning one or both of the video objects to other video sessions allows the video objects to move along trajectories that take them anywhere on the display area while avoiding the need for an image buffer large enough to hold data for all pixels in a rectangular display area containing all of the displayed video objects and interfering minimally with access to controls or other user interface features.

In certain embodiments, much or most of display area is not affected by video sessions 25. Thus, if display 14 is a display of a computer having a GUI, the presence within the display area of windows or other display regions corresponding to video sessions 25 does not prevent a user from interacting with applications or features of the GUI that are outside of the regions allocated for display of video images for video sessions 25. A user can even interact with applications or features of the GUI that are located directly between two separated display regions corresponding to different video sessions 25. Thus, the areas of the display that the windows corresponding to video sessions 25 prevent a user from interacting with are minimized. Interference with operability of a user interface can be further reduced by making all or portions of the windows or other display regions corresponding to video sessions 25 functionally transparent.

Where pixels of a window are functionally transparent, any control input associated with such pixels is passed to the application corresponding to the first non-transparent display window or other display object that is in the background relative to the current window at the location with which the control input is associated. This permits a user to interact in a way that appears to the user to be normal with any controls underlying functionally transparent pixels of an overlying window. Video players having functionally transparent pixels may be applied for displaying coordinated video presentations as well as in other applications.

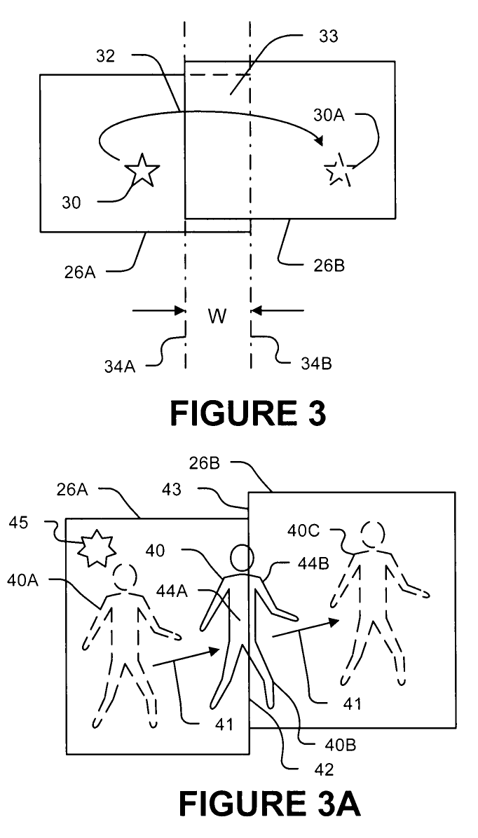

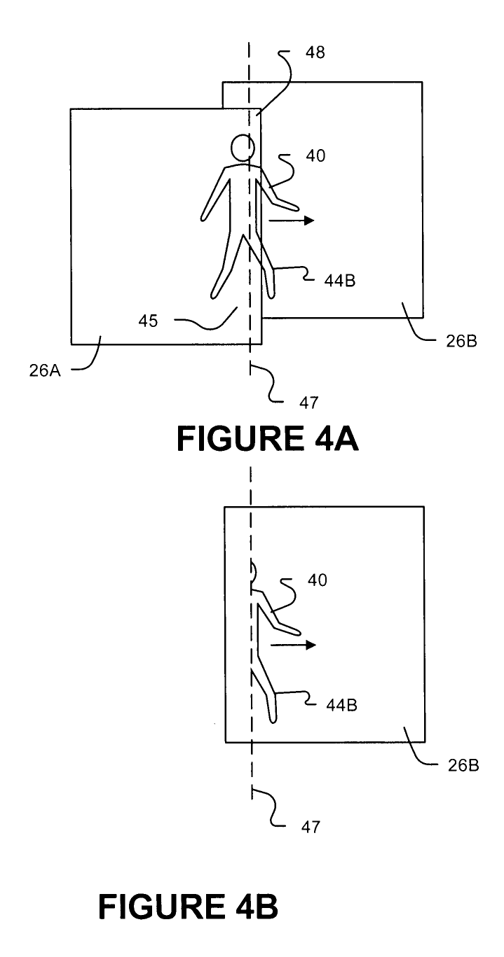

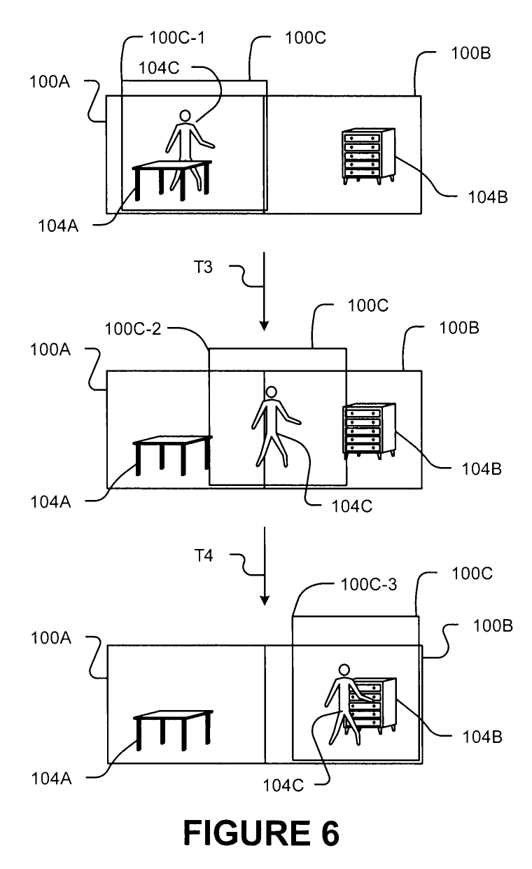

Transitions of a video object between different video sessions may be achieved in a variety of ways. For example, consider the case shown in FIG. 3 where a video object (star 30) is to follow a trajectory 32 that will take it from within an area 26A associated with a first video session to a position 30A that is within an area 26B associated with a second video session. Some possible transitions include:
If the width W of a region of overlap between windows 26 corresponding to first and second video sessions 25A and 25B is greater than a width of star 30 then star 30 could be displayed by first video session 25A until it is located in overlap region 33 and then discontinued from first video session 25A and shown instead in a corresponding location by second video session 25B. The transition could occur between one frame and the next. The transition could also have star 30 displayed at coinciding locations by both of video sessions 25A and 25B for a short period.
Portions of star 30 on one side of a transition line could be shown by first video session 25A. Any portions of the star 30 on another side of the transition line could be shown by second video session 25B. In such embodiments, when the star or other object is shown crossing the transition line, at least portions of the video object are depicted by each of the first and second video sessions 25. The transition line could be a boundary of one or both of video display areas 26A and 26B. Where the video display areas have a region of overlap, the line could be an arbitrary line (which could be straight or curved) located in or immediately adjacent to the region of overlap on or between the boundaries of the video sessions. The transition line is not necessarily straight. In embodiments wherein a transition line does not coincide with a boundary of a video display area care should be taken to ensure that any other video objects in the vicinity of the transition do not interfere with the visual integrity of the transition (for example, by showing other video objects that should be behind a transitioning object in front of a part of the transitioning object). Where the first and second video sessions overlap in the vicinity of the line, at least portions of star 30 could be displayed at coinciding locations by both of video sessions 25A and 25B for a period while trajectory 32 is taking star 30 across the line.
The star 30 may be depicted by video content of a third video session that has a corresponding display area layered on top of video display areas 26A and 26B (FIG. 5 shows an example of this type of transition). The third video session may be presented as non-rectangular video. During the transition, the display area corresponding to the third video session is progressively moved from being layered on top of first video display area 26A to being layered on top of second video display area 26B. To a viewer it appears that the video object in the third video session has moved from a location within the display area of the first video session to a location within the display area corresponding to the second video session (although, visually, there may be no indication that more than one video session is involved).
   An author preparing a coordinated video session which incorporates any of these transitioning techniques may keep track of the Z-order of different video display areas and of the possible presence of other video objects to ensure that a desired visual effect is produced.

FIG. 3A illustrates a simple transition of a video object from one video session to another. A first video session 25A initially displays a visible video object 40 (e.g. an actor or prop) in a corresponding display area 26A. Video object 40 is depicted as moving along a trajectory from a first position 40A, through a second position 40B to a third position 40C as indicated by arrows 41. In doing so, video object 40 approaches a boundary 42 of video display area 26A. In this example, boundary 42 is an edge of a rectangular region assigned to video session 25A. Boundary 42 may, for example, comprise the edge of a window assigned by an operating system of a computer driving a display upon which video objects from video sessions 25A and 25B are displayed.

As the leading pixel or pixels of video object 40 reach boundary 42 and the apparent motion of video object 40 would take object 40 into the area 26B of second video session 25B, the video content of video session 25B begins to show the video object 40 emerging from the boundary 43 into display area 26B of video session 25B. In the illustrated embodiment, the boundary 42 of video display area 26A abuts boundary 43 of video display area 26B so that, to a viewer, video object 40 appears to move across the boundaries without interruption. Video object 40 may be continuously visible to the viewer. There may be no visible manifestation of boundaries 42 or 43 so that the viewer is unaware that there has been any transition of video object 40.

During the transition, different parts of video object 40 are depicted according to the video data in different video sessions.

Second video session 25B may be created or placed adjacent to first video session 25A at any time prior to video object 40 reaching a location at which some part of video object 40 leaves the display area of first video session 25A and must therefore be shown by second video session 25B. In the illustrated embodiment, video object 40 moves into the display area of video session 25B from boundary 43 until video object 40 is completely contained within the display area of video session 25B and all parts of the video object 40 are depicted from video data being displayed by second video session 25B. Another video object 45 may remain in video session 25A.

The display of video in video sessions 25A and 25B are coordinated so that, during the transition of video object 40 across the boundaries of the two video sessions, no visual artifacts are introduced.

In the embodiment illustrated in FIG. 3A, the apparent seamless passage of video object 40 from first video session 25A into second video session 25B is provided by careful synchronization of the trajectories and display timelines of first and second video sessions 25A and 25B. For example, while video object 40 is straddling boundaries 42 and 43 (e.g. when it is in position 40B shown in solid outline) the portion 44A of video object 40 that appears within the region of video session 25A is provided in the video content for video session 25A whereas the portion 44B of video object 40 that is within the region of video session 25B is provided in the video content for video session 25B. In this embodiment, during the transition, portions of video object 40 appear in two separate pieces of video content.

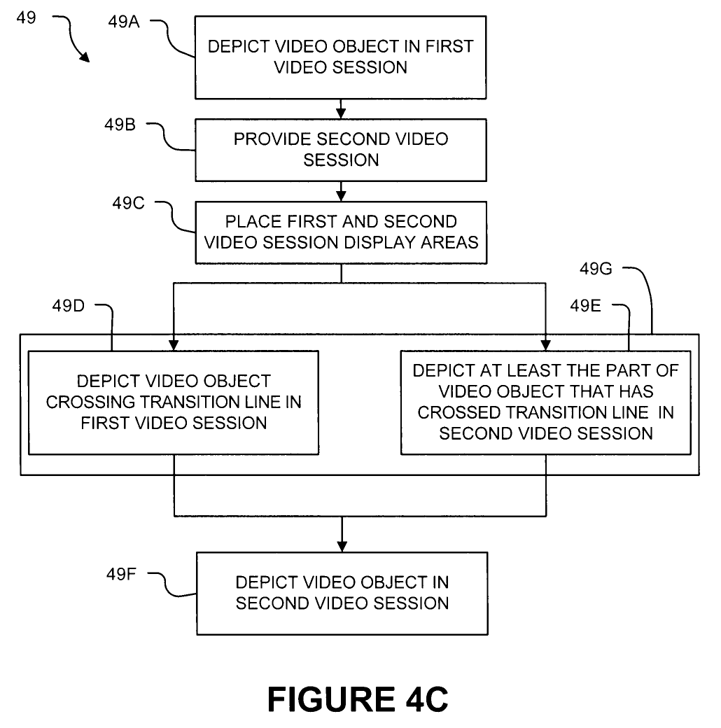

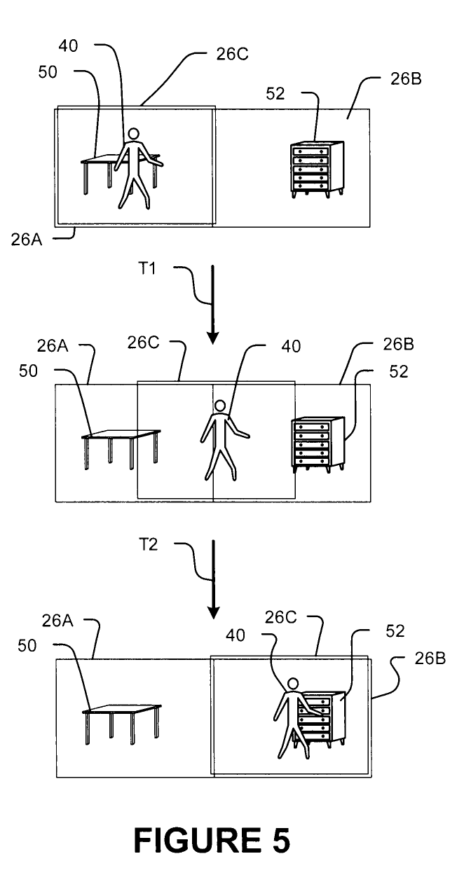

FIGS. 4A and 4B illustrate transitioning of video objects between overlapping video sessions. Such transitions may occur in a similar manner as described above in relation to FIG. 3A except that the transition occurs at a defined line lying at an edge of and/or within an overlap region of the video sessions. Where the video sessions overlap, other transitions are also possible.

FIG. 4A shows overlapping display areas 26A and 26B corresponding to first and second video sessions 25A and 25B. Video display areas 26A and 26B overlap within a region 45. The degree of overlap is specified at the time of video creation so that appropriate parts of video object 40 are provided by the video content for each of video sessions 25A and 25B so that video object 40 transitions from video session 25A to video session 25B at an internal boundary 47 that is somewhere in or immediately adjacent to overlap region 45. In the illustrated embodiment, the Z-order of windows 26A and 26B corresponding to video sessions 25A and 25B is such that the window for video session 25A appears to be in front of the window for video session 25B. In the illustrated embodiment, portions of video object 40 to the right of boundary line 47 are depicted by video content of video session 25B while portions of video object 40 to the left of line 47 are depicted by video content of video session 25A. Where, as depicted, line 47 is not at a boundary of window 26A, then it is desirable to avoid the presence of video objects in the portion 48 of window 26A to the right of line 47 that could anomalously be depicted in front of the transitioning video object 40 and to make the pixels in portion 48 visually transparent. In some embodiments, line 47 could be located such that it is aligned with a boundary of a window of one of video sessions 25A and 25B.

FIG. 4B is the same as FIG. 4A except that video session 25A is not shown so that video session 25B can be seen in isolation. In FIG. 4B, it can be seen that the video content for video session 25B depicts a portion 44B of video object 40 emerging from line 47 (line 47 is not part of the video content and is not displayed on the display).

FIG. 4C is a flow chart of a method 49 illustrating the transition of a video object from a first video session to a second video session. Method 49 can apply to the embodiments of FIG. 3A or FIGS. 4A and 4B. In block 49A a video object is depicted in a first video session while the display area of the video session follows a trajectory. In block 49B a second video session is provided. The second video session may be created or invoked in block 49B. In the alternative, the second video session may have been created or invoked at some earlier time. In any given application it may be advantageous to create a video session before it is needed. Until there are video objects to display in the video session, the video session may display nothing (playback is not in progress in the video session) or display only transparent pixels (playback is in progress in the video session). The video session provided in block 49B may have been created earlier and used previously to display video content.

In block 49C the display areas of the first and second video sessions are placed in known relative positions on a display such that the display areas abut or overlap. In block 49D the first video session depicts the video object moving across a transition line. A boundary or interior part of the display area of the second video session is adjacent the transition line in the direction of motion of the video object. In block 49E, the second video session depicts at least that part of the video object that has crossed the transition line. Blocks 49D and 49E are performed concurrently. In block 49F the second video session displays the entire video object. The transition itself occurs in block 49G.

One scenario in which it can be beneficial to transition video elements between video sessions using overlapping video sessions is the case where the video sessions comprise windows supported by the graphical user interface of a computer operating system (such as Windows from Microsoft Corporation, Unix or Linux running a GUI, Mac OS from Apple Inc., or the like. Some operating systems allow the display of window borders to be suppressed. Some such operating systems reserve space on the display, which would be taken up by the border, even when display of the border is being suppressed. In such cases the operating system may not allow one window to be positioned so that its content region abuts the content region of another window. This is especially the case if both windows have the same Z coordinate. This problem may be solved by giving windows for two or more video sessions different Z coordinates and positioning the windows so that they overlap at least enough that the content regions of the windows abut (it is assumed here that the border is considered part of the window).

FIG. 5 illustrates a coordinated video presentation involving a third video session 25C. Third video session 25C has a corresponding display area 26C that carries a video object from a location within or overlapping with display area 26A corresponding to first video session 25A to a location within or overlapping with display area 26B corresponding to second video session 25B. In some embodiments, third video session 25C exists only during the transition. Third video session 25C may be created just in time for the transition or at a suitable earlier time. Display areas 26A and 26B of video sessions 25A and 25B are adjacent to one another but do not need to be abutting. In this simple example, video session 25A initially depicts video object 50, which depicts a table, video session 25B initially depicts a video object 52 which depicts a chest of drawers and video session 25C initially depicts video object 40 which depicts a person. The display area 26C for Video session 25C is layered over top of the display area 26A for video session 25A.

In an alternative embodiment video object 40 is initially depicted by video session 25A but is transitioned into video session 25C. This may be done by commencing to include video object 40 in the video data for video session 25C and taking video object 40 out of the video data for video session 25A.

It is desired to give the impression that person video object 40 is walking from the vicinity of table video object 50 to chest of drawers video object 52. This can be achieved by moving video display area 26C from its initial position toward chest of drawers video object 52.

After a time T1 has passed, video display areas 26A, 26B and 26C may have the configuration shown in the middle part of FIG. 5. At this time, video display area 26C is positioned so as to overlap both video display areas 26A and 26B. Person video object 40 appears to have moved to a position about half-way between table video object 50 and chest of drawers video object 52. Person video object 40 straddles boundaries of video display areas 26A and 26B but this does not affect the display of person video object 40 because person video object is being displayed in third video display area 26C in response to video data from third video session 25C.

After passage of a further time T2, video display area 26C has been moved to the right until it is over video display area 26B. Person video object 40 is located in a position near chest of drawers video object 52. Video display areas 26A and 26B could each be moved if desired. Video display areas 26B and 26C could move in tandem with one another to maintain the appearance that person video object 40 is in the vicinity of the chest of drawers video object 52. Person video object 40 could optionally be transitioned into video session 25B by commencing to include person video object 40 in the video data for video session 25B and either discontinuing the inclusion of person video object in the video data for video session 25C or discontinuing the display of video session 25C.

The embodiment depicted in FIG. 5 can be convenient in cases where it is desired to scale a coordinated video presentation up or down since the video object can be entirely depicted by one video session at any given time.

Transitions of video objects between video sessions may occur in any direction. When two or more video sessions are adjacent to or overlap with one another, any number of video objects may transition among the sessions. Video objects may transition from a first video session to a second video session and/or from the second video session to the first video session. Having transitioned from one video session to another, a video object may transition back to the video session from whence it came, stay in the second video session or transition to a further video session that abuts or overlaps the second video session. Any combinations of such transitions is possible.

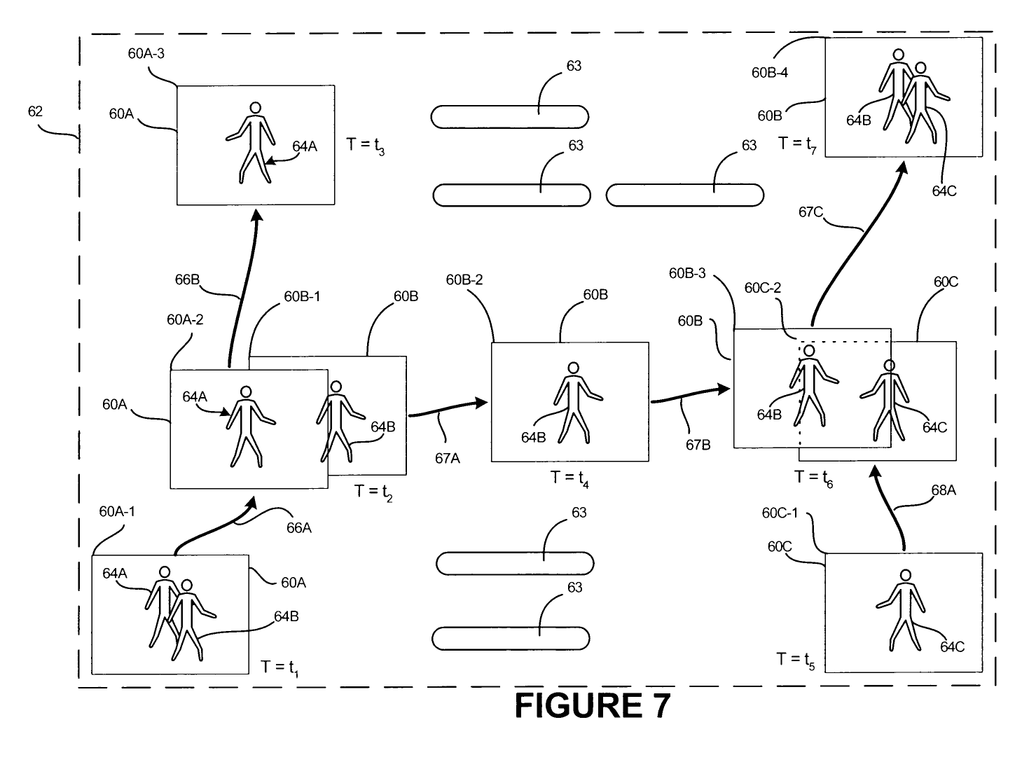

FIG. 6 illustrates another way to display video depicting foreground and background objects. In the embodiment of FIG. 6, different video objects are depicted in windows corresponding to different video sessions. A first window 100A corresponds to a video session which contains a video object depicting a table 104A. A second window 100B corresponds to a video session which contains a video object depicting a chest of drawers 104B. A third window 100C corresponds to a video session which contains a video object depicting a person 104C. The scene depicted in FIG. 6 is similar to that of FIG. 5 except that in FIG. 6, table 104A is shown as being in the foreground relative to the depicted person 104C. However, in FIG. 6, the Z-order of window 100C is such that it is in the foreground relative to windows 100A and 100B.

FIG. 6 creates the impression that person 104C is standing behind table 104A by not displaying those parts of the video data for the video session corresponding to window 100C that correspond to portions of the body of person 104C that would be obscured by table 104A if person 104C were behind table 104A. The image of table 104A is seen through ‘transparent’ pixels of window 100C. This may be achieved in various ways, for example:
Applying a mask or the like specifying that pixels in the areas of window 100C that overlap with the image of table 104A be transparent;
Removing from the video data to be displayed in window 100C those portions of the video data corresponding to portions of depicted video objects that should be obstructed by table 104A;
etc.
   Suitable video editing techniques may be used to implement clipping at the time that video data for the video session of window 100C is being prepared.

In FIG. 6, window 100C is moved from its initial position 100C-1 through an intermediate position 100C-2 to a position 100C-3. A viewer sees person 104C moving from behind table 104A to in front of chest of drawers 104B.

Other ways to depict a first object that is in the foreground relative to a second object include showing both of the first and second objects in a single video session.

As noted above, windows corresponding to one or more video sessions 25 may be moving relative to display area 15. Video objects depicted in video content for a video session 25 may be made to move within the video session with a velocity V_{OBJ} such that the vector sum of V_{OBJ} with a velocity of the video session V_{SESS} over display area 15 yields a desired velocity V_{APPARENT} of the video object on display area 15.

Apparatus 10 may terminate display of video sessions 25 or initiate display of new video sessions 25. The termination and creation of video sessions 25 may be coordinated with the display of content in other video sessions 25. These capabilities, if present, may be applied to deliver video fission and video fusion. For example:
A video fission effect may be performed by creating a new video session adjacent to or overlapping an existing video playback session. One or more video objects may be transitioned into the new video session. The new and existing video sessions may be moved on different trajectories that take them apart from one another. To the viewer it appears as if video objects have separated from each other to move independently around the display.
A video fusion effect may be performed by positioning two or more video sessions so that they are adjacent or overlapping. Video objects depicted in some of the video sessions (source sessions) may be transitioned into another of the video sessions (a receiving session). The video sessions may be moved on different trajectories that take them apart from one another after the video objects are transitioned. If, after the video objects are transitioned, one or more of the video sessions does not contain any remaining video objects, it may disappear. To the viewer it appears as if video objects have come together.

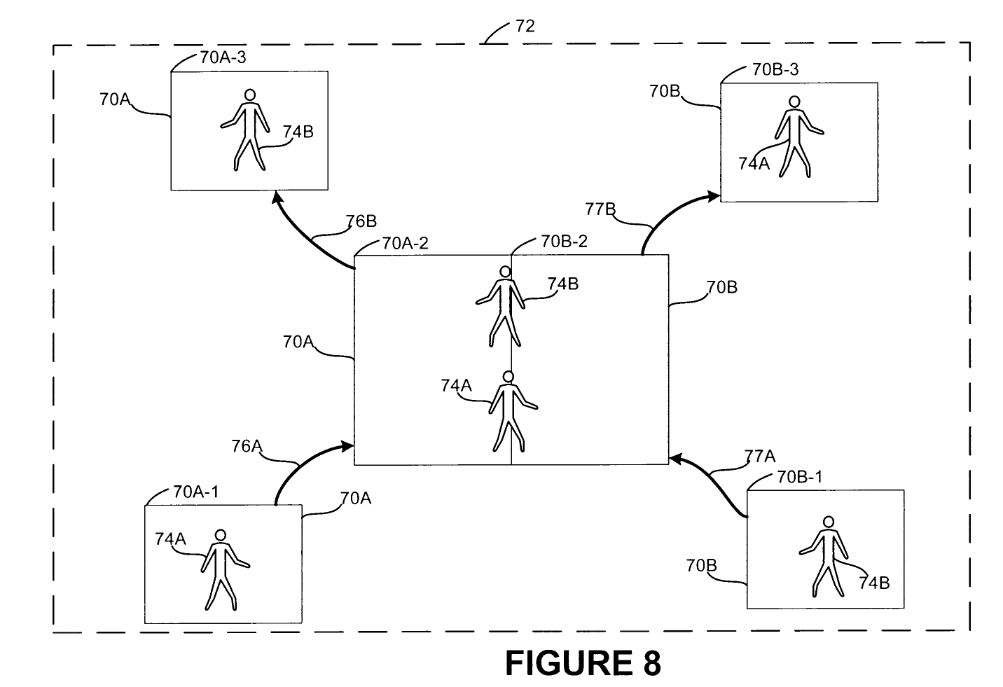

FIG. 7 is an example of a composite video sequence that applies video fission and video fusion. This example involves displaying video images on a display 62. Display 62 may comprise any suitable display. In an example embodiment, display 62 is a display of a computer having a GUI comprising various controls 63 that a user can interact with.

At time T=t1, a first video playback window 60A corresponding to a first video session is positioned in the lower left corner of display 62 at location 60A-1. At time t1, video data for the first video session shows a couple 64A and 64B walking together. As the video data of the first video session continues to play in window 60A, window 60A is moved along a trajectory 66A that takes it upward and to the right. At time t2 window 60A has reached location 60A-2.

At time t2 the video object representing person 64B is transitioned to a video playback window 60B corresponding to a second video session. After the transition, the image of second person 64B is specified in the video data associated with the second video session and displayed in second video playback window 60B. The image of first person 64A continues to be defined by video data corresponding to the first video session and displayed in window 60A. Video playback window 60B may be created and suitably positioned at any suitable time prior to time t2 when the transition occurs.

After video fission is completed, window 60A separates from window 60B and is moved along its trajectory 66B which carries window 60A upwardly to a position 60A-3 at time T=t3. At the same time, window 60B is moved from its initial position 60B-1 along a trajectory 67A to arrive at a position 60B-2 at time t4 and continuing on trajectory 67B to reach position 60B-3 at time t6.

In the meantime, at time T=t5, a new video playback window 60C is created at location 60C-1 in the lower right corner of display 62. Video playback window 60C corresponds to a third video session and plays video data containing a video object depicting a third person 64C. Window 60C is moved upward on a trajectory 68A to arrive at position 60C-2 at time T=t6.

At time t6, windows 60B and 60C are overlapped or otherwise positioned to permit transitioning of video objects between the corresponding video sessions. The video object representing third person 64C is transitioned to the video session of window 60B. After this transition, the video session of window 60B displays video objects representing both persons 64B and 64C. These video objects are both specified in the video data for the session of window 60B.

After the video object for person 64C has transitioned to the session corresponding to window 60B, window 60C is no longer required. Window 60C can be discontinued. Window 60B continues to be moved along trajectory 67C until it reaches position 60B-4 at time t7. During this time, window 60B continues to play video containing video objects 64B and 64C.

From the perspective of the viewer, it appears that a couple (represented by video objects 64A and 64B walked into the display from the lower left corner to the vicinity of the location 60A-2 where the couple split up. One person (represented by video object 64A) continued walking to the upper left corner of the display. The other person (represented by video object 64B) appeared to walk across display 62 to the vicinity of location 60B-3 where he or she met up with a third person (represented by video object 64C) who has arrived in the vicinity of location 60B-3 from the vicinity of location 60C-1 at the lower right corner of display 62. The new couple continues walking together up to the vicinity of location 60B-4 at the upper right corner of display 62.

To the viewer, this appears to be taking place directly on display 62 (e.g. on a ‘desktop’ provided by the GUI). Windows 60A, 60B and 60C (in general, windows 60) may lack visible borders. Windows 60A, 60B and 60C may be transparent except where video objects 64 are being displayed. The viewer is not aware that three video playback windows are involved.

Even though this example involves the display of video, in the foreground, at locations from one side of display 62 to the other and from top to bottom of display 62, the viewer can interact with controls 63 since controls 63 are not obscured by any video windows 60. Even where a video window 60 passes over a control 63, the video window 60 is moving along a trajectory and may only obscure access to the control 63 for a brief time. Further windows 60 may include portions that are transparent to control inputs (i.e. the windows may have “functionally transparent” portions) so that a viewer can interact with a control 63 even if it is partially or entirely overlapped by a window 60. Additionally, the total size of buffers used to hold image data for display in windows 60 may be much less than the size of buffer that would be needed to support a window capable of containing the entire coordinated video presentation.

The example illustrated in FIG. 7 uses three windows 60 however more or fewer windows 60 may be involved. At a minimum there must be two windows at some point in the playback timeline for video fission or fusion to occur. For example there may only be one window which fissions into two windows. There may be two windows that fuse into one window. There can also be three or more windows, any subset of which may participate in video fission and/or fusion.

FIG. 8 illustrates another example application. In the embodiment of FIG. 8, two windows come together, exchange video objects and then separate. The FIG. 8 scenario starts with two windows 70A and 70B in the lower left and lower right corners of display 72 respectively. Window 70A corresponds to a first video session playing video data that includes a video object 74A depicting, in this example, a first person. Window 70B corresponds to a second video session playing video data that includes a video object 74B depicting, in this example, a second person. Window 70A is moved along a trajectory 76A that takes it from position 70A-1 to position 70A-2. Similarly, window 70B is moved along a trajectory 77A that takes it from position 70B-1 to position 70B-2. Windows 70A and 70B are at positions 70A-2 and 70B-2 at the same time. Positions 70A-2 and 70B-2 are adjacent, abutting or overlapping to permit exchange of video objects between windows 70A and 70B. During this time, the video sessions of windows 70A and/or 70B may depict interactions between video objects. For example, the video objects depicting persons 74A and 74B may depict the persons shaking hands, hugging or the like.

In this example, video object 74A is transitioned to the video session of window 70B and video object 74B is transitioned to window 70A. At this point, an exchange of video objects between windows 70A and 70B has occurred. Subsequently, windows 70A and 70B continue along their respective trajectories 76B and 77B and separate from one another. Window 70A is moved upward and to the left on trajectory 76B to location 70A-3. Similarly, window 70B is moved upward and to the right on trajectory 77B to location 70B-3.

FIG. 9 illustrates an example embodiment in which video fission occurs into a window having a Z-order different from that of a window in which a video object is initially located. A video window 80A at location 80A-1 on display 82 displays video data for a video session that initially contains two video objects 84A and 84B. Window 80A has Z-order Z_{A}. Video object 84B is transitioned to a second video session displaying video data in window 80B at location 80B-1. Window 80B has a Z-order Z_{B} with Z_{B}<Z_{A} so that window 80B is in the background as compared to window 80A.

In this example, display 82 is displaying another object 88 having a Z-order Z_{C} with Z_{B}<Z_{C}<Z_{A}. After fission occurs (i.e. after video object 84B has completed the transition to the video session of window 80B, windows 80A and 80B are respectively moved along trajectories 86 and 87 to new positions 80A-2 and 80B-2. In the illustrated embodiment, window 80B appears to pass behind object 88 (which could be another window for some application, a GUI control, or the like) because Z_{B}<Z_{C}. Similarly, window 80A appears to pass in front of object 88 because Z_{C}<Z_{A}.

Performing video fission among the video sessions of windows having different Z-orders may be applied to particular advantage where the window of one of the video sessions is in the background relative to the window of another one of the video sessions. The larger window may have a Z-order which places it in the background relative to the smaller window. In this case, the smaller window may be positioned so as to completely overlap with the larger window (i.e. the smaller window is in the foreground relative to the larger window). With this configuration, video objects can be transitioned in either direction between the video session of the smaller window and the video session of the larger window at any part of the boundary of the smaller window.

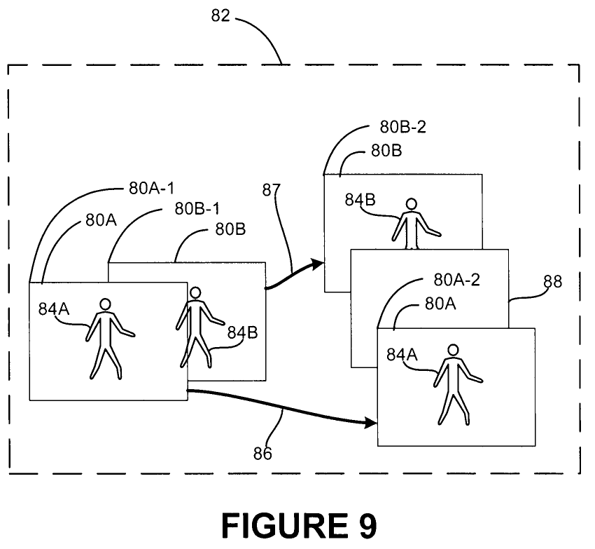

FIG. 10 shows an example application wherein video objects from a video session being played in a smaller window 90A are transitioned into the video session of a larger window 90B. Window 90A is initially located at position 90A-1 and is displaying video objects 94A and 94B. Window 90A is moved along trajectory 96 to location 90A-2 at which point it overlaps with and is surrounded by larger window 90B. Video objects 94A and 94B then transition to the video session of larger window 90B. In the illustrated embodiment, the transition of video object 94A occurs along the line 91A forming one segment of the boundary of window 90A and the transition of video object 94B occurs along a line 91B which forms another segment of the boundary of window 90A. After the transition, window 90A may be discontinued if there are no video objects left in the video data of its corresponding video session.

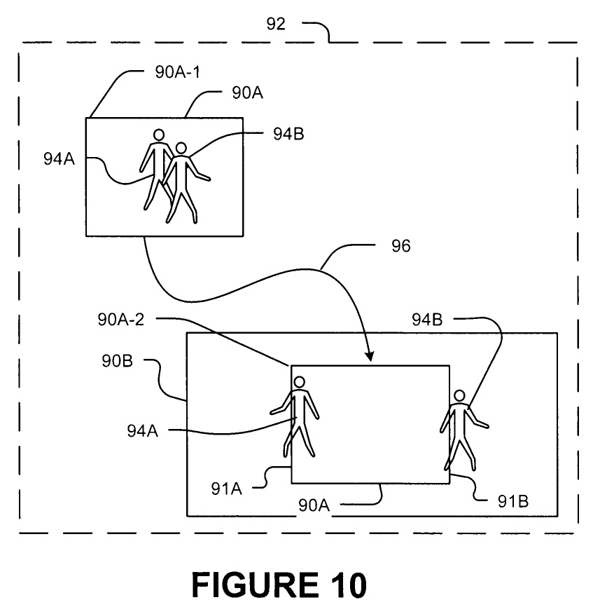

FIGS. 11 through 15 illustrate various techniques that may be applied to maintain coordination of aspects of the display of video data and trajectories of coordinated video sessions. FIG. 11, depicts a scenario where an instance of video fission involving window 110A occurs when window 110B is at position 110B-1 on a display 112. A video object representing a person 114A is transitioned from the video data for the video session corresponding to window 110A to the video data for the video session corresponding to window 110B. After the transition, window 110B is moved along a trajectory 116 and arrives at a position 110B-2 at a later time. The motion of window 110B along trajectory 116 may be smooth or irregular. FIG. 11 shows snapshots of window 110B at various points along trajectory 116. An instance of video fusion involving windows 110B and 110C occurs when window 110B is at position 110B-2.

A trajectory for a window may be specified in a wide range of ways including:
Providing information specifying positions that the window should be in at specific times relative to a reference time;
Providing information specifying velocities for the window at specific times;
Providing a function that generates window positions, velocities or other trajectory information as a function of time or another measure of progress along the trajectory;
etc.

The trajectory for a window such as window 110B may be encoded in any suitable manner. For example:
A position could be associated with each frame of the video being displayed in window 110B. If the video is playing at a rate of 30 frames per second, this would result in 30 slight position changes every second to approximate smooth motion of window 110B along trajectory 116;
Specific positions could be associated with selected video frames only. Positions for intermediate frames could be determined on-the-fly by a suitable function such as linear interpolation, interpolation by a higher polynomial function, etc.
Specific positions could be associated with selected video frames only. The window position could jump between those frames. If necessary, the positions of video objects specified by the video data could be shifted in time with the jumps so that the display of video does not appear jerky.
Time stamped position, velocity, and acceleration vectors could be specified for selected times or positions of the window.
etc.
   As will be readily appreciated by those skilled in the art, there are many additional ways of encoding the trajectory along which the window will be moved.

It can be desirable to permit adjustment of the distances over which windows are moved according to their specified trajectories. Such a capability may be applied, for example, to adjust a coordinated video presentation for display areas of different sizes and shapes. If a large display area is available then it may be desirable to stretch specified trajectories to make them longer so that the coordinated video presentation uses the available display area effectively. If the same coordinated video presentation is to be presented on a smaller display area then the trajectories may be compressed to make them smaller. Adjustment of the distances over which windows are moved may also be used to adapt coordinated video presentations for display on displays having different aspect ratios. For example, the same coordinated video presentation may be adapted to play properly on displays having 4:3 aspect ratios and displays having 16:9 aspect ratios by scaling window trajectories.

By way of example, a conventional video presentation is typically designed to be played back on a display having a specified aspect ratio. When a video presentation designed to be displayed on a display having a 16:9 aspect ratio is played back on a display having a 4:3 aspect ratio, the presentation must either be displayed so that it does not fill the display (e.g. the display is letter-boxed by leaving black stripes above and below a display area) or edge parts of the video presentation are clipped.

By contrast, in an example embodiment of the invention, a coordinated video presentation can be adapted for display on a display area having a 4:3 aspect ratio or a 16:9 aspect ratio (or another aspect ratio) by scaling trajectories of different display areas that display video content for the coordinated video presentation. Scaling may be accomplished by scaling trajectories corresponding to video sessions and/or scaling the video images displayed by the video sessions. It is advantageous that scaling of a coordinated video presentation to cover a larger or smaller display or part of a display may be accomplished without scaling the video objects or the display areas in which the video objects are displayed. Thus, in some embodiments, scaling can be accomplished without changing the compositing of video at all.

One approach to scaling trajectories is to scale the encoded motion so that the specified trajectories will take windows involved in the coordinated video presentation to desired positions. For example, a trajectory may specify a nominal change in position. For example, suppose that the encoded motion specifies that a window should move over a trajectory that will move it to a new position that is +3 units on the X axis and −2 units on the Y axis away from its current position. It may be desired to present the presentation on a larger display within which the window is displaced by +5 units on the X axis and −3 units on the Y axis. The desired motion may be achieved by scaling all X components of any positions that define the trajectory by 1.67 and scaling all Y components of position that define the trajectory by 1.5. This will cause a window following the trajectory to move the desired +5 and −3 units.

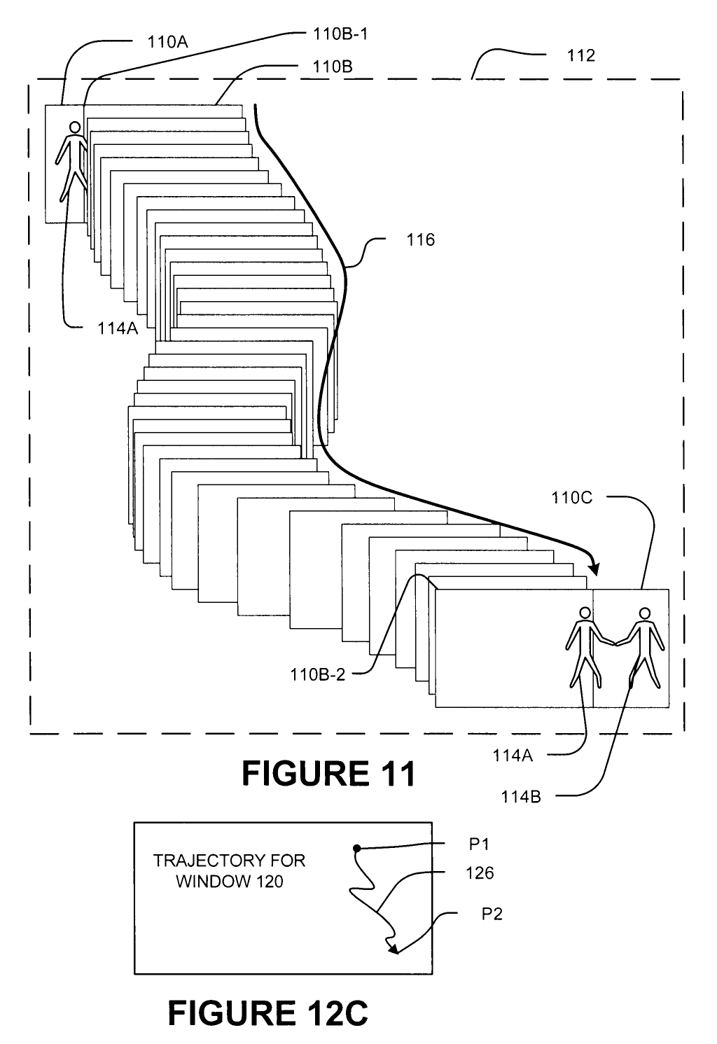

FIGS. 12A, 12B and 12C illustrate scaling of encoded motion. FIGS. 12A and 12B illustrate different display areas (respectively 122A and 122B) on which is displayed a coordinated video presentation featuring a window 120 for which a trajectory 126 is specified. Trajectory 126 is shown in FIG. 12C and extends between a start point P1 and an end point P2.

Display 122A of FIG. 12A is larger than and has a different aspect ratio from display 122B of FIG. 12B. In each case, the overall coordinated video presentation is scaled to fit into the display. The sizes and video content of window 120 may be the same in each case. Only the motion of window 120 is scaled in this example. The motion may be scaled differently in X and Y directions.

In FIG. 12A, specified trajectory 126 is scaled to provide scaled trajectory 126A. In FIG. 12B, specified trajectory 126 is scaled by a different amount to provide scaled trajectory 126B. Scaled trajectories 126A and 126B have the same general shape as specified by trajectory 126 but cover different distances. End point P1-A of scaled trajectory 126A and end point P1-B of scaled trajectory 126B are both near the top left corners of their respective display areas. End point P2-A of scaled trajectory 126A and end point P2-B of scaled trajectory 126B are both near the bottom right corners of their respective display areas.

In some applications it is convenient to provide embodiments in which a trajectory is specified in terms of a size of the window following the trajectory. In such cases, it is possible to achieve minor adjustments of the position of a window at the end of a specified trajectory by resizing the window slightly as it follows the trajectory. For example, the horizontal component of motion for a window might be encoded as “move right at 0.05 window widths per second”. The vertical component of motion for the window might be encoded as “move up at 0.03 window heights per second”. The total amount of motion of the window over a specified time period is dependent on the size of the window. Therefore, adjustments to the position of the window at the end of its trajectory can be made by changing the size of the window as it is moved along its trajectory. If the window is expanded or shrunk slightly during playback, the total motion will increase or decrease respectively. If the size of the window is not changed very much and it is changed in the middle of playback then the size changes may not be noticeable to a viewer.

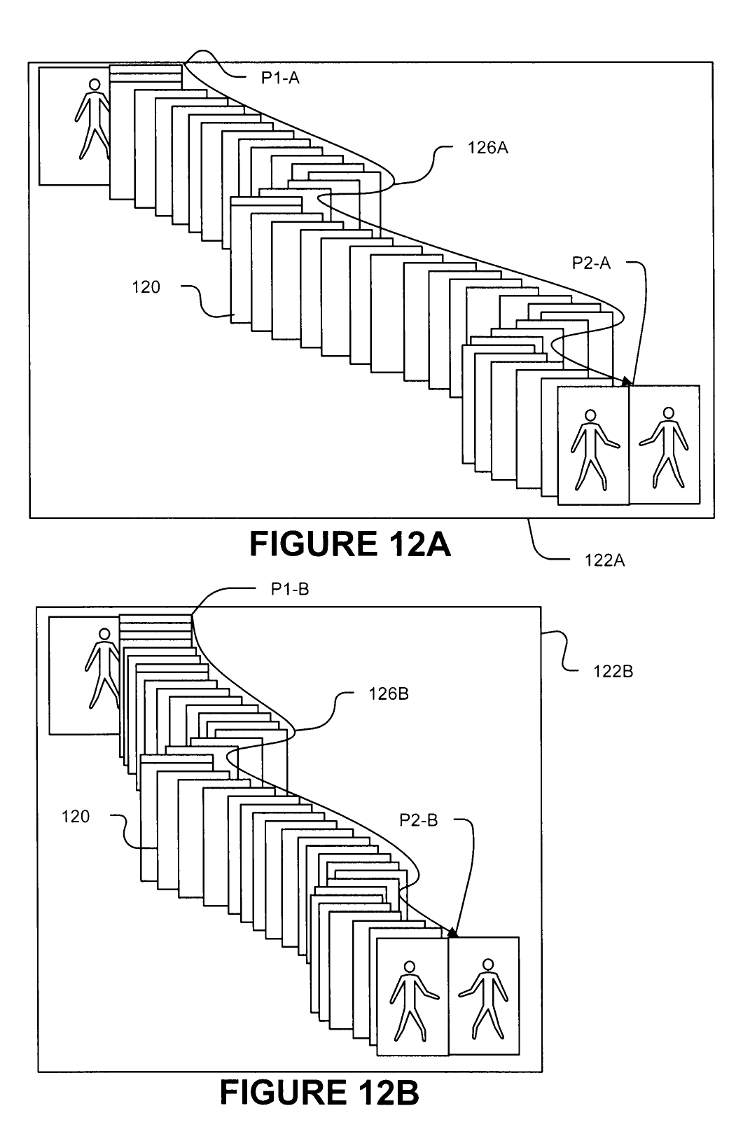

FIG. 13 illustrates the use of window size changes to control the position of a window at the end of a trajectory. The top portion of FIG. 13 shows a series of snapshots of a window 130A moving across a display 132. A constant direction and rate of motion has been specified by the encoding defining a trajectory 136. The lower portion of FIG. 13 shows another series of snapshots of a window 130B for which the trajectory 137 is specified in the identical manner. Windows 130A and 130B are initially the same sizes. Window 130A begins trajectory 136 in position 130A-1 which is vertically aligned with a position 130B-1 at which window 130B begins its trajectory 137. The difference between the two series is that in the lower series, window 130B has been expanded slightly during a period 135 occurring while window 130B is being moved along trajectory 137 and then returned to its original size. It is unlikely that a casual viewer will notice that window 130B expanded and contracted slightly while moving along its trajectory 137. This is especially the case if arbitrary-shaped video is being displayed.

Expanding window 130B has caused the total change in position of window 130B during trajectory 137 to be increased slightly. This has resulted in the final position 130B-2 of window 130B to be a distance D1 to the right of the final position 130A-2 of window 130A. An adjustment of the final position of window 130B to the left could be achieved by shrinking window 130B slightly as it is moved long its trajectory. The vertical distance traveled along trajectory 137 is also increased in comparison to the vertical distance traveled along trajectory 136. In some embodiments, separate control over horizontal and vertical positions of endpoint 130B-2 is achieved in whole or in part by expanding and/or shrinking a moving window by different amounts in horizontal and vertical directions during a portion of a trajectory.

Another way to alter the final location of a window being moved along a trajectory is most conveniently applicable in cases where motion along the trajectory is specified for certain video frames. For example, a trajectory may be specified in terms of a certain horizontal distance and/or a certain vertical distance to move for each video frame. In such a case, the endpoint of a trajectory may be adjusted by varying the number of video frames played while the window is being moved along the trajectory. This technique is particularly applicable where the video content for the window includes some frames that are not critical to the presentation so that the viewing experience will not be adversely affected if the frames are not played. These frames (and any corresponding motion) could be omitted during playback to cause the distance by which a window is moved along a trajectory to be reduced. Similarly, an extra sequence of frames could be added to cause the distance by which a window is moved along a trajectory to be increased. Frames that can be dropped from or added to a video sequence in order to affect the distance moved along a trajectory in coordination with playback of the video sequence may be tagged or otherwise marked as being capable of being dropped or added. In the alternative, frames that ought not to be dropped may be tagged or otherwise marked.

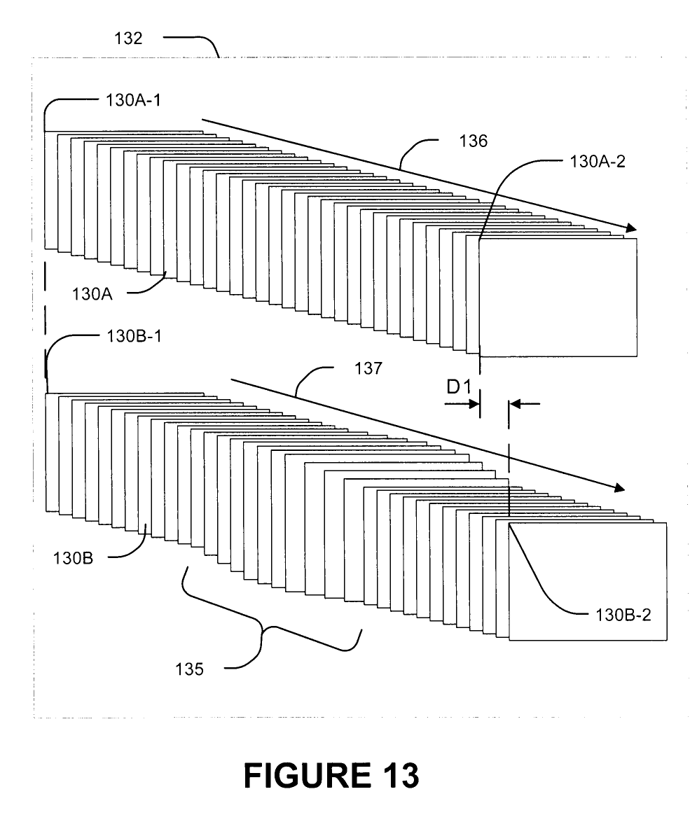

FIG. 14 illustrates adjusting the endpoint of a trajectory of a window by varying the number of video frames played while the window is moved along the trajectory. The upper part of FIG. 14 shows a series of snapshots of a window 140A which is initially in a first position 140A-1 and then moves along a trajectory 146A to another position 140A-2. The middle part of FIG. 14 shows a series of snapshots of a window 140B which is initially in a first position 140B-1 and then moves along a trajectory 146B to another position 140B-2. The lower part of FIG. 14 shows a snapshots of a window 140C which is initially in a first position 140C-1 and then moves along a trajectory 146C to another position 140C-2. Positions 140A-1 and 140B-1 and 140C-1 are aligned vertically.

Windows 140A, 140B and 140C are associated with video sessions which play the same video data. The video data comprises a series of video frames. A subset 148 of the video frames is tagged or otherwise marked as being not critical to the presentation. A set 149 of additional video frames may optionally be added to the presentation. The video content of frames 148 and 149 is such that frames 148 can be removed or frames 149 can be added without affecting significantly the continuity of the video presentation.

In FIG. 14, window snapshot 148A displays the last video frame preceding optional section 148 and window snapshot 148B displays the first video frame following optional section 148. As shown in the middle part of FIG. 14, frame 148B is displayed immediately after frame 148A if optional section 148 is skipped.

The lower part of FIG. 14 shows an optional set of video frames represented by window snapshots 149 being inserted into the video sequence. Window snapshot 149A displays the video frame preceding the optional section and window snapshot 149B displays the video frame following the optional section. The optional section can be played in between frames 149A and 149B. The optional frames are included in the video data for the video session associated with window 140C but they are tagged or otherwise marked as being optional. The optional frames can be added in case final position 140C-2 needs to be moved farther from initial position 140C-1 for some reason.

It can be seen from FIG. 14 that dropping video frames 148 as shown in the middle portion of FIG. 14 permits final position 140B-2 to be a distance D2 to the left of the position 140A-2 that is gained when section 148 is not skipped. It can also be seen that adding video frames 149 results in a final position 140C-2 that is a distance D3 to the right of position 140A-2.

If a trajectory for a window is specified by positions for individual frames (as opposed to an amount of motion for each frame played back) then, to achieve adjustment of the endpoint of a trajectory by inserting or removing frames, the positions of the window at which video frames are played may be adjusted. This preferably done smoothly to avoid the motion of the window along the trajectory becoming jerky. For example, where optional frames 149 are added to a video sequence, the positions of the window corresponding to playback of frames coming after the optional frames 149 may be adjusted. By opening up a gap for the optional video frames, the following frames are pushed out further along the path of window motion extending the overall distance traversed by the window as it is moved along the trajectory. Similarly, relocating frames after a skipped portion 148 of video into the gap left when optional video frames 148 are not displayed can shorten the overall path of motion.

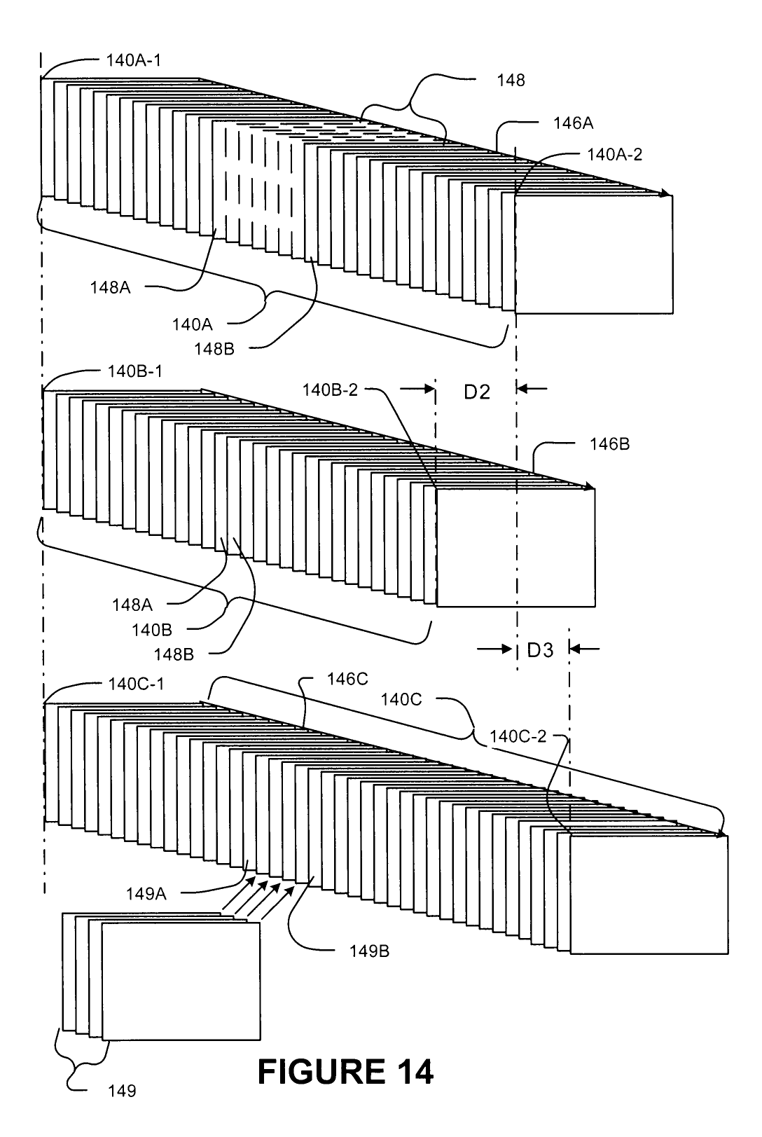

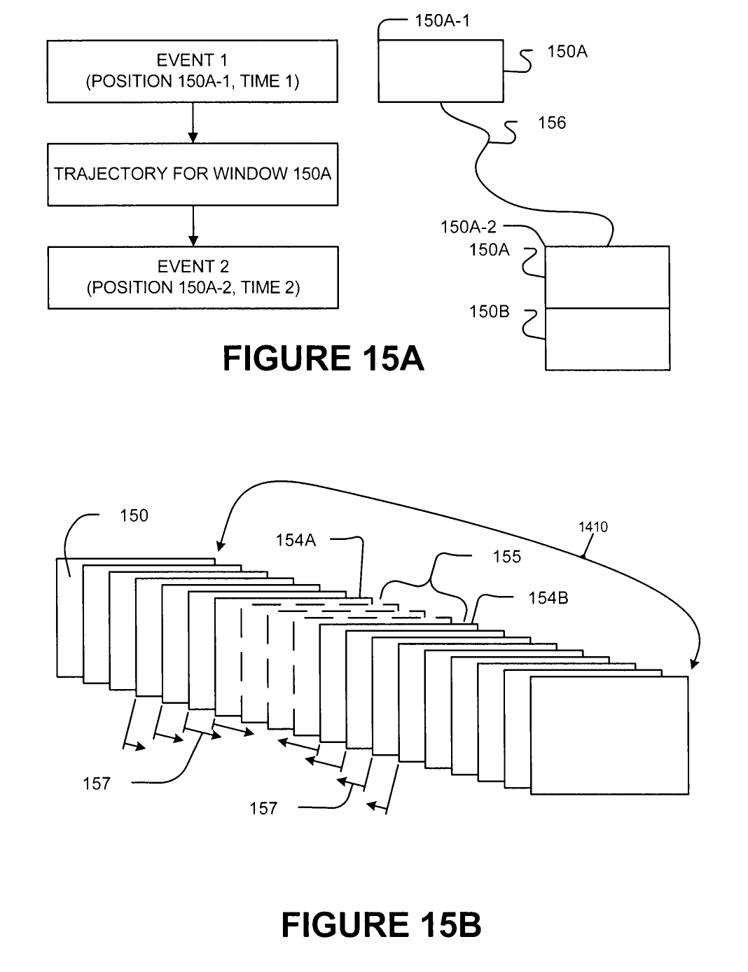

Trajectories and playback of video in different video sessions can be adjusted to maintain coordination of the timing of events in different video sessions and/or to ensure that windows corresponding to different video sessions are appropriately positioned in space relative to one another. Consider the case illustrated in FIG. 15A. Window 150A must travel along a trajectory 156 from a first position 150A-1 to a second position 150A-2. Furthermore, window 150 must arrive at position 150A-2 no later than a time (TIME 2) at which an event will occur (e.g. transfer of a video object from the video session of window 150A to a video session of another window 150B that will be adjacent to window 150A when window 150A is at position 150A-2). The frames of the video in window 150A that correspond to the event must be played at the same time as the corresponding frames of the video in the other window 150B that correspond to the event.

The part of the video to be played in window 150A while window 150A is moved along trajectory 156 should have a duration such that it is completing immediately before the event. The subsequent video frames that correspond to the event are thus ready to play in synchronization with corresponding frames of video in window 150B. This can be achieved by selecting a piece of video to be played in window 150A that has exactly the right duration at the specified frame rate (e.g. 30 frames/second) to be completed in time for the video corresponding to the event to play at the scheduled time in synchronization with video played in window 150B.

Some embodiments provide a mechanism for adjusting the time taken to play back the part of a video to be played during a trajectory or otherwise played between events. By combining adding or dropping frames with varying the rate of playback, the playback duration of a given video sequence may be varied with a fine degree of control over a reasonably wide range of playback durations.

Varying the time taken to play back a video sequence may be done, for example, by adding or dropping frames or altering a frame rate. This adjustment may be performed by apparatus for playing coordinated video presentations and/or by apparatus for authoring coordinated video presentations. Where such a mechanism is present, while authoring a coordinated video presentation, it is not necessary that the video sequence be selected to have a duration at its nominal frame rate that exactly matches a required duration. In such embodiments, the playback of the video sequence may be automatically adjusted so that the video sequence playback completes at the required time. The adjustment may stretch or shrink the duration of the video sequence.

Suppose that the natural playback duration of the video to be played during trajectory 156 and the interval (TIME 2−TIME 1) differ by a small percentage. Such a mismatch could be compensated for by speeding up or slowing down the rate at which frames are displayed in window 150A to shorten or lengthen the playback duration. If the difference between the frame rate at which the video is played back in window 150A and the nominal frame rate of the video is only a few percent, a casual viewer will probably not notice the slight rate change. This technique does not affect the path taken by playback window 150A. Window 150A will move slightly faster or slower along the same path if progress along trajectory 156 is tied to the rate of display of video frames.

If the playback duration and the interval (TIME 2−TIME 1) differ by more than a small percentage, it may be possible to accommodate the difference by adding or dropping frames from the video sequence being played as window 150A traverses trajectory 156. The video sequence may include frames marked as being optional to display. A number of such frames sufficient to cause the video sequence to have the desired duration could be selected and played. In some cases, the optional frames could include frames that are normally played but can optionally be not played and frames that are normally not played but are optionally played.

In some embodiments, the spatial locations of a window along a trajectory corresponding to the playback of frames may be adjusted to achieve a desired visual effect. For example, if a window is being moved spatially according to a trajectory while a video sequence is being played in the window and the trajectory is specified by associating positions with specific frames then adding or dropping frames to increase or decrease the time taken for the window to traverse the trajectory could cause jerkiness in the apparent motion of video objects being displayed in the window as the window moves along its trajectory. To avoid this, window positions for frames that are played may be dynamically reassigned. For example, where a number of frames are not displayed at a location in a video sequence, positions associated with remaining frames may be adjusted toward the center of the gap. Where a number of frames are added at a location in a video sequence, the positions corresponding to frames coming before or after the insertion may be moved away from the insertion. This can be done without altering locations of frames corresponding to initial and final points along the trajectory (unless there is also a reason to alter one or both trajectory endpoints).

One algorithm for adjusting the positions of a window to fill in a gap created by the removal of optional frames is to determine a desired path from the default positions associated with both the displayed video frames and the optional video frames. The positions specified for the displayed video frames can be dynamically reassigned to different positions along the desired path so that displayed video objects will appear to move smoothly.

An alternative approach to adjusting the positions of a window to fill in a gap and/or to accommodate the play back of optional frames is to associate two or more positions with some or all of the video frames. Each set of positions may be chosen to provide desired motion quality along the desired trajectory for a particular scenario (e.g. for a particular set of frames that are played). Which of the sets of positions is used may depend upon factors such as whether or not any optional frames are displayed. Other algorithms for window repositioning may also be applied.

FIG. 15B illustrates a situation where an optional subset of video frames, represented by window snapshots 155 of a window 150, is not displayed. Window snapshot 154A displays the last video frame before the optional section. Window snapshot 154B displays the first video frame following the optional section. Without any adjustment in window positioning, window 150 will quickly jump from the position of window 150 in snapshot 154A to the position of window 150 in snapshot 154B, as the video playback progresses directly from the video frame displayed when window 150 is at position 154A to the video frame displayed when window 150 is at position 154B. Instead, as indicated by arrows 157, the position specified for window 150 is smoothly adjusted into the gap. The motion of window 150 will appear to speed up in the adjusted section, but if the adjustment is spread over a long enough segment of video frames the speed change will not be noticeable to a casual viewer.

As noted above, methods according to embodiments of this invention involve providing separate sets of video data for each of a plurality of video sessions. The separate sets of video data may come from any of a wide variety of sources and may be encoded for delivery to the respective video sessions in any of a wide variety of ways.

The video data may comprise, for example:
video data obtained through use of one or more video cameras;
computer-generated content;
animation;
or the like.

Control data for functions such as:
creating new video sessions;
causing windows to be displayed or not displayed;
positioning windows;
moving windows along trajectories;
changing the Z-order of windows;
identifying critical, optional or non-critical frames;
identifying video frames which must be exactly coordinated with corresponding video frames in video data for another video session;
or the like;
   may be provided together with or separately from video data. In some embodiments, control data is provided as metadata together with video data. For example, MPEG-4 and various other video formats allow arbitrary metadata to be associated with individual frames of a video segment. Control data may be provided in the form of such metadata. The control data may cause a controller to perform functions specified by the control data.

In some embodiments, coordination among a plurality of video sessions in a coordinated video presentation is provided by a centralized controller. In other embodiments, the function of coordination is distributed.

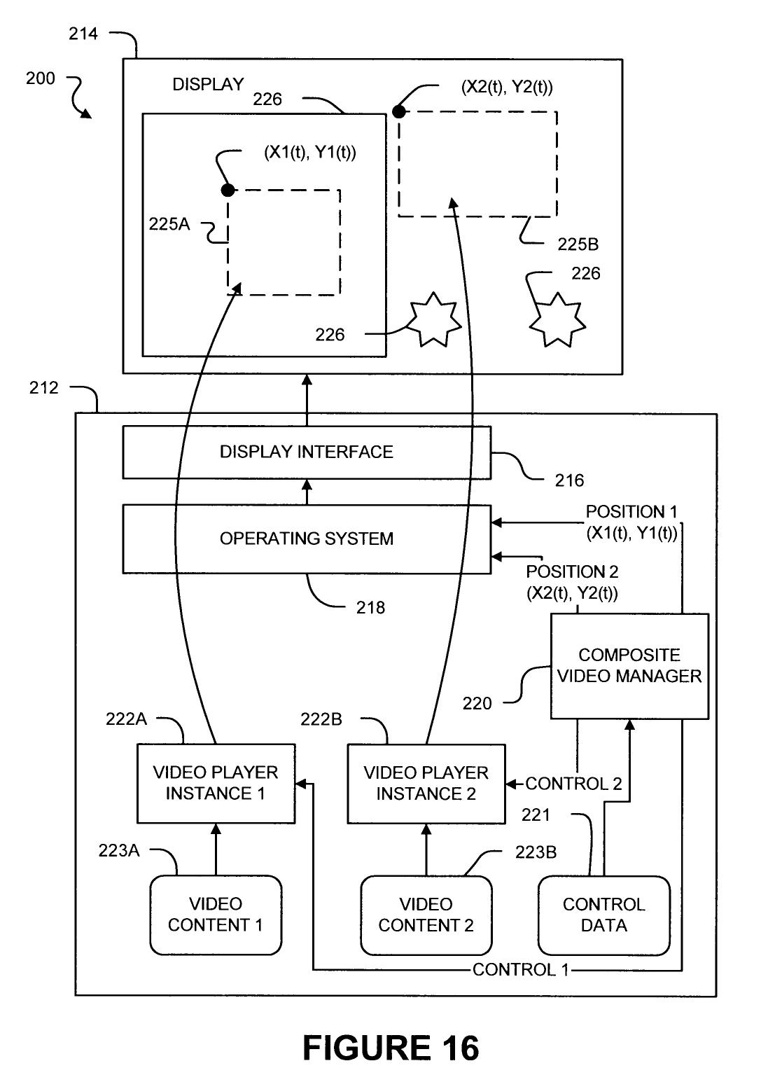

FIG. 16 shows apparatus 200 according to an example embodiment in which a centralized manager 220 functioning in a computer apparatus 212 coordinates the operation of a plurality of video sessions to provide a coordinated video presentation. Composite video manager processes control data 221 and in response sends control signals (CONTROL 1 and CONTROL 2) to a plurality of video player instances (222A and 222B are shown but there may be more, potentially many more, video player instances). Control data 221 specifies the choreography of the coordinated video presentation including things such as when and where windows 225 (e.g. 225A and 225B are shown) corresponding to video sessions should be displayed on a display 214, what trajectories windows 225 should move along, and so on.

In the illustrated embodiment, composite video manager also communicates with an operating system 218 of computer apparatus 212. Composite video manager 220 may, for example, cause operating system 218 to invoke new video player instances 222 or move or re-size windows 225. Video player instances 222 generate separate sets of video image data that is passed to display 214 by way of operating system 218 and suitable display interface 216 to be displayed in corresponding windows 225. Controls presented by a GUI associated with operating system 218 on display 214 are not affected by windows 225 that leave them exposed.

Communication to operating system 218 may be direct or indirect. Example embodiments may transmit required data (such as positions and sizes of windows 225 etc.) to operating system 218 by one or more of:
direct communication between composite video manager 220 and operating system 218;
communication between composite video manager 220 and video player instances 222 which pass required data to operating system 218;
communication between video player instances 222 and operating system 218 (in such embodiments, video player instances 222 may read or otherwise obtain the necessary data without intervention from composite video manager 220);
etc.
   The nature of the communication may be selected for compatibility with the operating system.

In some embodiments, control data 221 and multiple sets of video content are provided in a single file or data stream. In such cases, apparatus 200 may comprise a module that extracts from the file or data stream any required control data 221 and separates video content 223 for display by different video player instances 222.

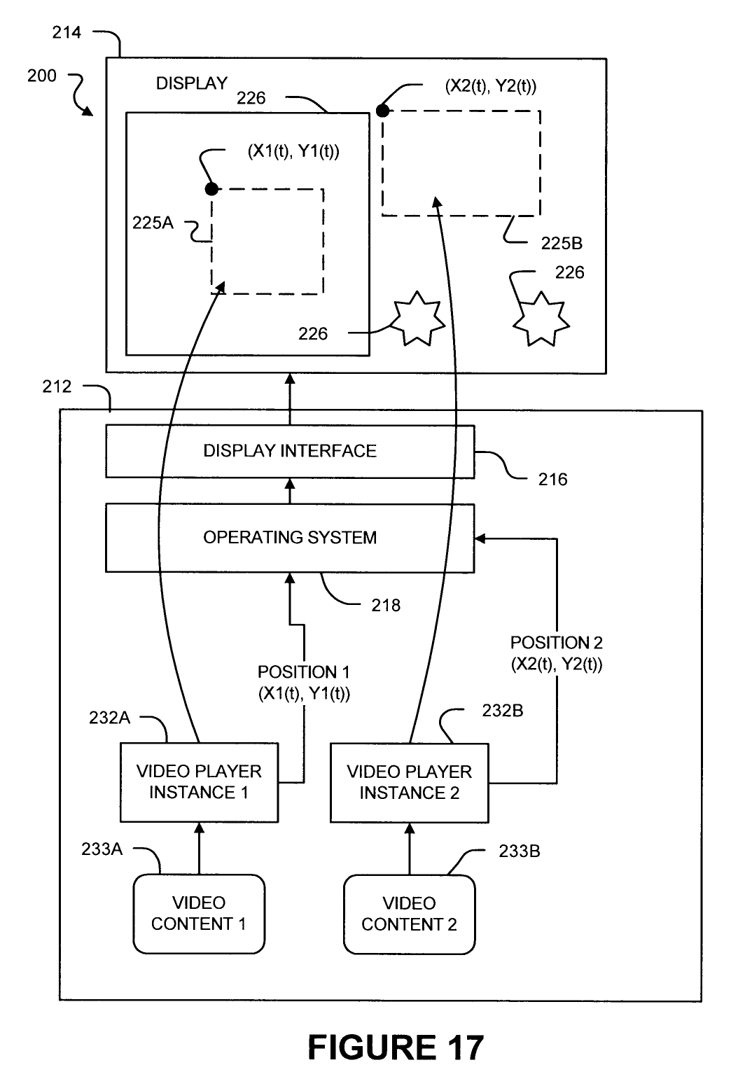

In alternative embodiments, an explicit composite video manager 220 is not required. For example, FIG. 17 illustrates an embodiment wherein control data for choreographing the playback of video in windows 225 is contained in corresponding video data 233. A plurality of video player instances 232 (instances 232A and 232B are shown) extract the control information and cause operating system 218 to display the required windows at the required positions on display 214. Video player instances 232 also supply image data to be displayed in the corresponding windows.

A suitable mechanism for coordinating the operation of video player instances 232 is provided. A range of suitable mechanisms are possible. For example:
One video player instance 232 may be a ‘master’ instance. The master instance may be identified, for example, by control data encoded in its video content 233. The master instance may communicate with other video player instances 232 by sending a synchronization signal to all or specified other video player instances 232. The synchronization signal may be used solely for time synchronization but in the alternative, may have another function.
Video player instances could negotiate with one another using peer-to-peer negotiation methods to establish a common reference time and/or otherwise coordinate playback and choreography of their respective windows.
One video player instance may serve in the same manner as the composite video manager 220 of FIG. 16 and also serve as a player for one set of video content 233.
All video player instances 232 may be triggered by some event affecting computer 212. The time of occurrence of the event establishes a reference time.
and the like.

The mechanism for coordinating the operation of video player instances 232 may coordinate the spatial locations at which windows corresponding to video player instances are displayed on a display. The spatial locations are determined in part by characteristics of the display in some embodiments. For example one video player instance may be identified as or set to be a master and the spatial positions of windows for other video player instances may be set relative to a position of the window corresponding to the master video player instance. In some other embodiments, each video player determines a location for its own window relative to the display.

During, or in preparation for, playback of a coordinated video presentation, adjustments may be made to the times that will elapse when certain video segments are played back and/or to the locations that windows containing video objects will have at different times in the playback of the coordinated video presentation. These adjustments may be made to do any or all of:
maintain a desired choreography;
correct for imprecision in the durations of video selections selected during authoring;
adjust a coordinated video presentation for display on displays of different sizes;
adjust a coordinated video presentation for display on displays having different form factors;
adjust a coordinated video presentation to play back within a different area or to play back in a different manner in response to inputs from a user interface or other sensor(s) such as accelerometers, inclination sensors (e.g. inclinometers, tilt sensors), or the like;
etc.
   Such adjustments may be made by one or more of:
adding frames;
dropping frames;
duplicating frames;
altering a frame rate during all or part of the playback of a video sequence;
reassigning window positions;
redefining trajectories;
scaling trajectories;
scaling the size of windows;
scaling the size of video objects depicted in windows;
etc.

Another aspect of the invention provides a video player for which some or all pixels within a window may be made functionally transparent or both functionally and visually-transparent. MPEG-4 and other formats permit some pixels to be designated as transparent. Where a pixel is transparent, the content of the pixel is set according to the value for the pixel in the first non-transparent display window or other display object that is in the background relative to the current window.

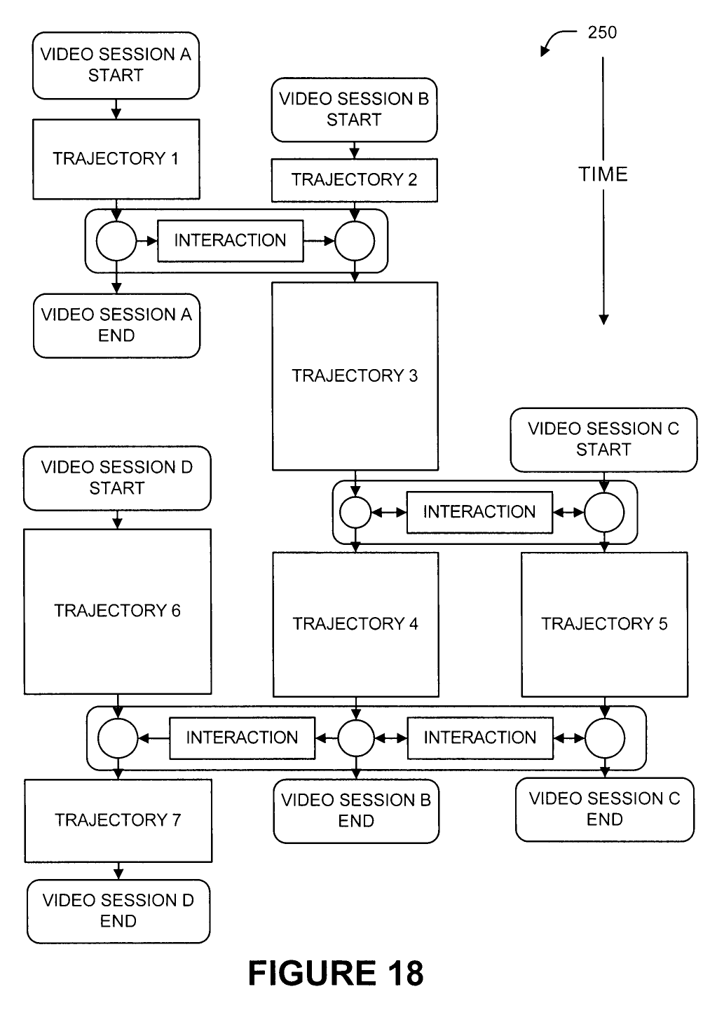

FIG. 18 shows a how the choreography of a coordinated video presentation may be expressed in the form of a graph 250. Graph 250 includes a plurality of nodes at which video sessions start displaying video content, terminate display, or interact with other video sessions. Different video sessions are linked by interaction nodes. Each video session follows a trajectory between nodes (staying still is a special case of trajectory). A position (or information from which a position can be derived) is specified for each video session for each node. It can be seen that the basic structure of graph 250 can be preserved while stretching or shrinking trajectories in one or more dimensions of space and/or time.

A coordinated video presentation may be defined initially by defining the topology of a graph 250 and specifying the video content to be played by each video session of the graph. At display time the graph may be adapted to allow playing of the coordinated video presentation on a particular display or within a defined display area by one or more of:
stretching and/or compressing trajectories in X and/or Y directions;
stretching and/or shrinking windows for the video sessions;
etc.
   The techniques described above are examples of ways in which such stretching and/or shrinking may be achieved.

Video fission, fusion and/or exchange may occur at nodes which are common to different video sessions. A graph 250 may have a default display area. Minor changes in the available display area away from this default may be achieved by scaling graph 250 to fill the available display area. For major departures of the available display area from the default display area, position, motion, and time management techniques as described above, can allow individual trajectories within graph 250 be adjusted. This effectively allows portions of the graph to be stretched or squashed (compressed) in space, time, or both to adapt to changing circumstances.

For playback on very small displays, such as the displays of cellular telephones and other portable digital devices, certain video segments, video fission nodes and/or video fusion nodes that are not critical to the presentation can be dropped or a number of nodes and video segments may be replaced with a single video segment. Playback of some video segments may be started late and/or stopped early.

In some embodiments one or more characteristics that affect the playback of a coordinated video presentation may be set in response to an input from a sensor or user interface control. Characteristics that may be changed include:
The size of an area within which the coordinated video presentation is played back.
The shape of an area within which the coordinated video presentation is played back.
The video content played back in one or more video sessions.
The curvature of trajectories.
   A graph or other representation of trajectories for video sessions may be scaled in response to resizing and/or changing the shape of the display area within which playback of the coordinated video presentation occurs. In some embodiments, a trajectory and/or orientation of one or more video sessions can be affected by a signal from an inclination sensor, accelerometer or the like. The inclination sensor or accelerometer or similar sensor may be mounted to a display on which a coordinated video presentation is presented or provided in a separate user control, for example. In such embodiments, trajectories of video sessions may be controlled in response to the signal.

As a simple example, a video session representing a falling object may have its trajectory on a hand-held display automatically adjusted in response to a signal from an inclinometer so that the object appears to fall downward regardless of the orientation in which a user is holding the display. As another example, if an acceleration sensor indicates that the display or a controller or the like has been suddenly shifted in a particular direction the trajectories of video sessions being depicted on the display may be altered in response to provide a visually-interesting result.

As another example, the video content of a video session may be chosen based at least in part on the value of a signal from one or more inclination sensors and/or acceleration sensors. For example, a video session may display video content depicting an actor walking flat when an inclinometer indicates that a display is being held in a level orientation. The video content may switch to video content depicting the actor walking uphill or sliding downhill (depending on the direction of tilt) when the inclinometer detects that the display is tilted.

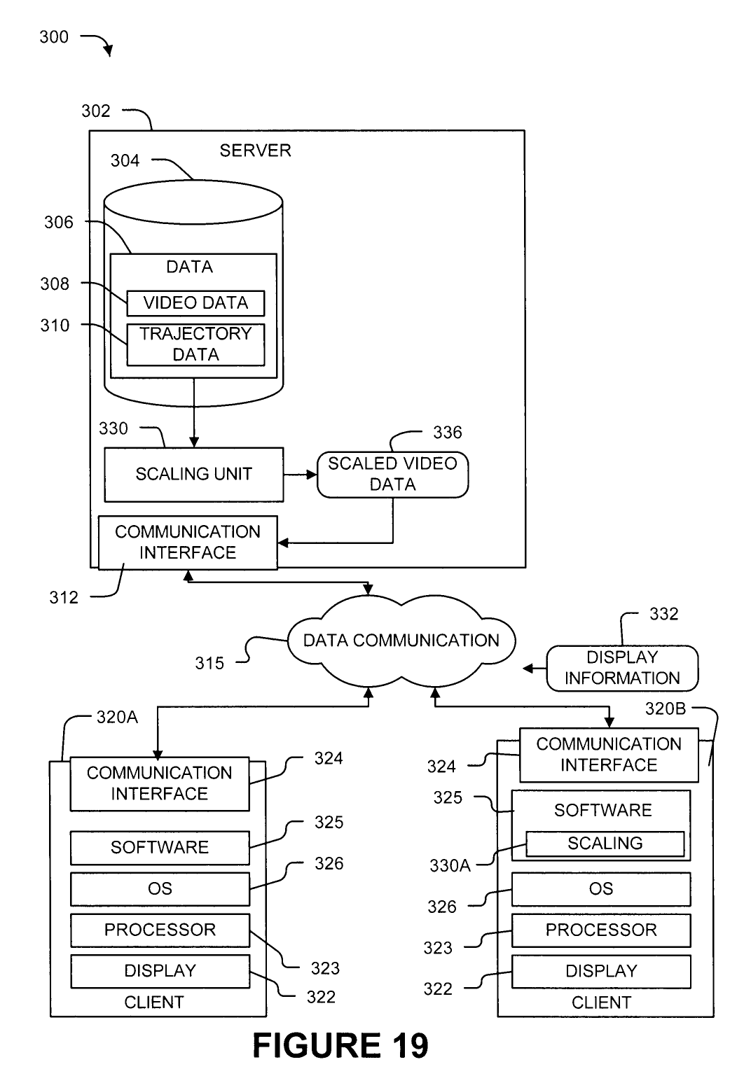

FIG. 19 illustrates a system 300 for delivering coordinated video presentations by way of data communication networks. FIG. 19 shows a server 302 having a data store 304 containing data 306 for one or more coordinated video presentations. For each coordinated video presentation data 306 includes video data 308 for two or more video display windows that will be part of the coordinated video presentation and trajectory data 310 for the video display windows.

Server 302 has one or more communication interfaces 312 for communicating with clients by way of a data communication network 315. Data communication network 315 may be provided by one or more of the internet, a local area network, a wireless channel, a telephone network, or the like. FIG. 19 illustrates two clients 320. Each client 320 has a display 322, a processor 323, a data communication interface 324 and software 325 operating under an operating system 326 for presenting coordinated video presentations on display 322. A first client 320A is a portable device, such as a cellular telephone, and has a relatively small screen which constitutes its display 322. A second client 320B has a larger display 322.

Server 302 receives requests for the performance of coordinated video presentations at clients 320. In the illustrated embodiment, server 302 comprises a scaling module 330. Server 320 receives from a client 320 display size information 332 identifying the dimensions of a display or portion of a display on which the coordinated video presentation will be presented. In response to the display size information, scaling module 330 scales the selected coordinated video presentation for display on the display of the client 320. Scaling module 330 scales data 306 to cause the coordinated video presentation to play within the area indicated by display size information 332. Depending upon the size and shape of the area within which the coordinated video presentation must play, scaling unit 330 may perform one or more of:
scaling trajectory data 310;
scaling video data 308 to play back in larger or smaller windows;
selecting different versions of trajectory data 310 and/or video data 308;
simplifying a graph representing the coordinated video presentation by dropping some nodes;
etc.
   In some embodiments scaling unit 330 scales at least in part by altering trajectories for windows within the coordinated video presentation. This may involve, for example scaling or replacing trajectory data 310. In some embodiments scaling unit 330 alters X and Y components of trajectories specified by trajectory data 310 in different ways (for example to alter an aspect ratio of an overall area within which windows of the coordinated video presentation are played without distorting video data 308.

Scaled video data 336 is delivered to the selected client by way of interface 312 and network 315. The scaled video data is played under control of software 325 to cause performance of the coordinated video presentation on display 322.

Instead of, or in addition to, scaling a coordinated video presentation at server 302 for playback on a client 320, scaling may be performed at client 320. In FIG. 19, client 320B includes a scaling module 330A for this purpose.

A coordinated video presentation may include audio as well as video. Audio may be contained with some or all video data or one or more separate audio tracks may be provided. Other control signals may be delivered in a synchronized manner with the performance of a coordinated video presentation may also be provided. For example, a coordinated video presentation may include MIDI information.

The invention may be embodied in any of a variety of ways. Some non-limiting examples are:
coordinated video presentation player software;
software and apparatus for authoring coordinated video presentations;
a general-purpose or specialized computer having a GUI and a system for presenting coordinated video presentations on a display that also displays controls of the GUI and/or windows of other applications;
a plug-in software module for an existing application such as a web browser, a document viewer, or the like that permits coordinated video presentations to be provided in a display area accessible to the existing application;
methods for delivering coordinated video presentations;
digital cinema systems having facilities for playback of coordinated video presentations;
portable devices, such as cellular telephones, configured to play coordinated video presentations;
server systems for supplying coordinated video presentations to clients by way of a data communication network; and,
video players.

A system which facilitates coordinated video presentation as described above, may be very flexible. Authors of video presentations may achieve similar visual effects in a range of different ways. For example, an author or authoring tool may trade off the use of dynamic window resizing against the use of video fission and/or video fusion. In a case where two or more video objects are located reasonably close to one another during playback, an author may be able to elect between depicting all of the video objects in a window corresponding to one video session and dynamically resizing the window or transitioning one or more of the video objects into one or more other video sessions (which could be new video sessions and/or existing and available video sessions). Where the video objects remain relatively close to one another, it may be desirable to avoid the complexity of video fission and to instead dynamically resize a window of one video session to accommodate the wider spread of video object positions. If the author wishes the video objects to move farther apart then the author may elect to transition one or more of the video objects into one or more other video sessions.

A user is free to interact with applications, web sites, and other content that is not obscured by the video playback windows. Let the “range” of the coordinated video presentation be defined as the rectangular area on a display having corners (X_{MIN}, Y_{MIN}) and (X_{MAX}, Y_{MAX}), where X_{MIN} and X_{MAX} are the minimum and maximum values for the X coordinate of any pixels affected by the coordinated video presentation and Y_{MIN} and Y_{MAX} are the minimum and maximum values for the Y coordinate of any pixels affected by the coordinated video presentation. Then, in some embodiments, there exist one or more interactive elements not associated with the coordinated video presentation within the range of the coordinated video presentation and a user can interact with those interactive elements during playback of the coordinated video presentation (for example, by placing a cursor over one of the interactive elements using a pointing device and clicking a button or other user control.

Non-limiting example applications of coordinated video presentations include:
video advertisements intended for use on web sites and displayed in web browsers;
video components of computer games that share a desktop computer display with other applications;
video tutorials (e.g. tutorials on the topic of the use of computer applications or computer operating systems);
video animations to be displayed on portable digital appliances;
etc.

While a number of example aspects and embodiments have been discussed above, those of skill in the art will recognize certain modifications, permutations, additions and sub-combinations thereof. For example:
In some cases, it may be desirable to display video objects and other objects which remain stationary. In such cases it would be possible to provide the stationary objects in the form of sessions which provide still images.
The display area in which a coordinated video presentation is presented does not need to be the entire area of a display. For example, a coordinated video presentation could be delivered within the area of a window of a web browser application. A user could interact with hyperlinks or other controls provided by the web browser while the coordinated video presentation is being delivered.
If desired, a contiguous area on a display may be made up by a mosaic of two or more smaller areas in which video data is presented by separate video sessions. To a viewer, such a mosaic can be indistinguishable from a single area displaying data from one video session as long as the positions and boundaries of the video sessions are carefully aligned and the video data is appropriately divided among the sessions.
   It is therefore intended that the following appended claims and claims hereafter introduced are interpreted to include all such modifications, permutations, additions and sub-combinations as are within their true spirit and scope.

What is claimed is:

1. A method for presenting a coordinated video presentation, the method comprising:
displaying first video content in a first video session within a first area on a display, the first area occupying less than all of the display;
while displaying the first video content in the first area, causing the first area to traverse a first trajectory on the display until the first area is in a predetermined spatial relationship to a second area on the display corresponding to a second video session, wherein the first area is abutting or overlapping the second area; and,
while the first area is abutting or overlapping the second area depicting a first video object from the first video content in the first area, transitioning the first video object to the second video session and subsequently depicting the first video object from the second video content in the second area.

2. A method according to claim 1 wherein transitioning the video object to the second video session comprises moving the video object across a transition line, displaying portions of the video object on a first side of the transition line from the first video content and displaying portions of the video object on a second side of the transition line from the second video content.

3. A method according to claim 1 wherein transitioning the first video object to the second video session comprises:
moving the first video object to a portion of the first area wherein the video object lies within the second area; and,
displaying the first video object from the second video content in the second area and discontinuing showing the first video object in the first video session.

4. A method according to claim 1 wherein the first video content includes a second video object and the method comprises continuing display the second video object in the first video session after transitioning the first video object to the second video session.

5. A method according to claim 1 comprising initiating the second video session after commencing displaying the first video content in the first video session.

6. A method according to claim 1 comprising displaying a third video object from the second video session in the second area prior to transitioning the first video object to the second video session.

7. A method according to claim 6 comprising continuing to display the third video object from the second video session in the second area after transitioning the first video object to the second video session.

8. A method according to claim 6 comprising, before, after or simultaneously with transitioning the first video object to the second video session transitioning the third video object to the first video session.

9. A method according to claim 1 comprising discontinuing to display video content in the first video session on the display after transitioning the first video object to the second video session.

10. A method according to claim 1 wherein causing the first area to traverse a first trajectory on the display comprises reading trajectory information and moving the first area according to the trajectory information.

11. A method according to claim 10 wherein the trajectory information specifies at least one of a speed and direction for the first area.

12. A method according to claim 10 wherein the trajectory information specifies intended positions for the first area at a plurality of times during the trajectory.

13. A method according to claim 1 wherein the display comprises a computer monitor and both of the first and second areas are areas within an application window displayed on the computer monitor.

14. A method according to claim 13 wherein the application window comprises a web browser.

15. A method according to claim 1 wherein the display is connected to receive display data from a computer and the first and second areas are respectively areas of first and second windows allocated to the first and second video sessions by an operating system of the computer.

16. A method according to claim 15 comprising writing the first video content into a first buffer allocated by the operating system to correspond to the first area and writing the second video content into a second buffer allocated by the operating system to correspond to the second area.

17. A method according to claim 1 comprising scaling the coordinated video presentation.

18. A method according to claim 17 wherein the scaling changes an aspect ratio of a range of the coordinated video presentation.

19. A method according to claim 17 wherein the scaling comprises stretching the first trajectory in at least one dimension.

20. A method according to claim 19 wherein stretching the first trajectory comprises inserting one or more frames into the first video content.

21. A method according to claim 20 wherein the first trajectory is defined at least in part by positions corresponding to frames of the first video content and the method comprises adjusting the positions corresponding to frames of the first video content occurring after the inserted one or more frames.

22. A method according to claim 19 wherein stretching the first trajectory comprises expanding the first area while the first area is being caused to traverse the trajectory.

23. A method according to claim 17 wherein the scaling comprises shrinking the first trajectory in at least one dimension.

24. A method according to claim 23 wherein shrinking the first trajectory comprises deleting one or more frames from the first trajectory.

25. A method according to claim 24 wherein the first trajectory is defined at least in part by positions corresponding to frames of the first video content and shrinking the first trajectory comprises adjusting the positions corresponding to frames of the first video content occurring adjacent to the one or more deleted frames.

26. A method according to claim 23 wherein shrinking the first trajectory comprises shrinking the first area while the first area is being caused to traverse the trajectory.

27. A method according to claim 23 wherein the first trajectory is defined at least in part by positions corresponding to frames of the first video content and shrinking the first trajectory comprises adjusting the positions corresponding to frames of the first video content.

28. A method according to claim 17 wherein scaling the coordinated video presentation comprises altering a frame rate of one or both of the first and second video content.

29. A method according to claim 1 comprising adjusting a time taken for the first area to traverse the first trajectory.

30. A method according to claim 29 comprising increasing a time taken for the first area to traverse the first trajectory.

31. A method according to claim 30 comprising inserting frames into the first video content and displaying the inserted frames while causing the first area to traverse the first trajectory.

32. A method according to claim 30 comprising displaying the first video content at a reduced frame rate while causing the first area to traverse the first trajectory.

33. A method according to claim 29 comprising decreasing a time taken for the first area to traverse the first trajectory.

34. A method according to claim 33 comprising skipping frames of the first video content while causing the first area to traverse the first trajectory.

35. A method according to claim 33 comprising displaying the first video content at an increased frame rate while causing the first area to traverse the first trajectory.

36. A method according to claim 1 wherein the first video content comprises a sequence of video frames and the first trajectory is represented at least in part by trajectory information associated with a plurality of video frames of the sequence of video frames.

37. A method according to claim 36 wherein the trajectory information comprises a window position associated with each of the plurality of video frames.

38. A method according to claim 1 wherein the first trajectory is specified by a function P=(X(t), Y(t)); where X(t) and Y(t) are some functions of time.

39. A method according to claim 38 wherein the first trajectory comprises a change in a Z-order corresponding to the first video session.

40. A method according to claim 1 comprising obtaining a signal from a motion sensor wherein the first trajectory is based in part on the signal from the motion sensor.

41. A method for displaying a coordinated video presentation, the method comprising:
displaying on a display one or more interactive elements of a graphical user interface and, on the display:
displaying a plurality of windows;
playing related video content in each of the plurality of windows; and,
for one or more of the plurality of windows, moving the one or more windows on the display, based at least in part on predetermined trajectory information, while playing the video content in the one or more windows.

42. A method according to claim 41 comprising receiving user input associated with one of the interactive elements while playing the related video content.

43. A method according to claim 42 wherein the one of the interactive elements is located directly between two of the windows while receiving the user input.

44. Apparatus for performing a coordinated video presentation, the apparatus comprising:
a display;
a plurality of buffers respectively associated by an operating system with a corresponding one of a plurality of areas of the display;
software running under the operating system and configured to:
write video content into each of the plurality of buffers; and,
move a location of one or more of the areas of the display in synchronization with the video content according to trajectory data.

45. Apparatus according to claim 44 comprising a scaling unit configured to scale the coordinated video presentation.

46. Apparatus according to claim 44 comprising a motion sensor wherein the software is configured to move the location of the one or more of the areas of the display based in part on an output of the motion sensor.

47. Apparatus according to claim 46 wherein the motion sensor comprises at least one of an accelerometer and an inclinometer.
